(19) United States
(12) Patent Application Publication
(10) Pub. No.: US 2018/0174138 A1
(43) Pub. Date: Jun. 21, 2018

(54) PROCESSING PAYMENT TRANSACTIONS WITH DYNAMIC PAYMENT TOKEN GENERATION AND EXCHANGE

(71) Applicant: Facebook, Inc., Menlo Park, CA (US)

(72) Inventors: Anand Subbarayan, Fremont, CA (US); Yegnashankar Parasuram, Cupertino, CA (US); Shuo Song, Palo Alto, CA (US); Kevin Patrick Hurley, Menlo Park, CA (US)

(21) Appl. No.: 15/387,326

(22) Filed: Dec. 21, 2016

(51) Int. Cl. G06Q 20/36; G06Q 20/10; G06Q 20/02; G06Q 20/40

(52) U.S. Cl. CPC G06Q 20/3674; G06Q 20/102; G06Q 20/4016; G06Q 20/409; G06Q 20/027

(57) ABSTRACT

The present disclosure relates to systems, methods, and devices for device and system agnostic payment tokenization for processing payment transactions. In particular, the message system allows a user to initiate a payment transaction with a recipient. For example, one or more implementations involve dynamically selecting, based on a plurality of factors associated with the payment transaction, a payment tokenization method from one of a network tokenization method, a gateway tokenization method, or a third party tokenization method. One or more embodiments also dynamically select, based on a plurality of factors associated with the payment transaction, a token exchange method from one of a client-side exchange method, a server-side exchange method, or a direct exchange method.

### BACKGROUND

### Background and Relevant Art

Electronic payment systems allow users to perform payment transactions with others via software applications on one or more types of devices (e.g., desktop devices and mobile devices). Some electronic payment systems allow users to perform payment transactions with financial institutions or merchants (i.e., peer-to-business payment transactions). For example, some electronic payment systems allow users to enter into payment transactions for goods or services with a merchant by way of an electronic payment application or a web browser on a computing device.

Some conventional electronic payment systems provide secure payment transactions by implementing tokenization of payment credentials to prevent sensitive information from being exposed to other parties. For example, some conventional systems integrate with a payment gateway system (such as BrainTree) to obtain gateway payment tokens for processing payment transactions via the specific gateway system. Payment tokens allow users to initiate payment transactions with merchants without allowing merchants or others to obtain and view the payment credentials (e.g., a credit card number). Although the gateway payment tokens provide a layer of security between the users and the merchants, users are still required to provide payment credentials to the gateway system. In particular, traditional electronic payment systems that use gateway tokenization store payment credentials at the payment gateways in association with users' payment credentials. By storing payment credentials of users at gateway systems, conventional electronic payment systems introduce security risks by increasing the number of locations and entities that have the payment credentials. In particular, merchants choose a payment gateway system and consumers are typically forced to use the merchant's chosen payment gateway if they want to make an electronic purchase from the merchant. Because the gateway payment token is limited to a specific gateway system, the tokens are not valid for use with other payment gateways. Thus, consumers that shop at multiple different merchants may end up having their payment credentials stored by multiple different payment gateways or even multiple times by the same payment gateway.

Furthermore, gateway payment tokens, are typically only valid with for a specific merchant using and a specific payment gateway combination. As such, the merchant sets up the relationship with the payment gateway and controls when gateway payments tokens are used (merchants typically do so to avoid storing credit card information and dealing with PCI compliance rules). Thus, individual consumers do not have the ability to set up and use conventional gateway payment tokens as a way of minimizing the exposure of their credit card information to merchants.

Consumer-friendly payment gateways (such as PayPal and Amazon Payments), unlike conventional payment gateways, provide individual consumers the option to make payments without providing a merchant with credit card information via the use of a payment token. For example, such consumer-friendly payment gateways often allow the merchant to include a payment option on their website or in their native application that allows the consumer to pay using an account with the consumer-friendly payment gateway rather than providing credit card information to the merchant. Unfortunately, in order for merchants to provide such an option, the merchant must integrate with the consumer-friendly payment gateway. In other words, the merchant must use the consumer-friendly payment gateway as their payment gateway or integrate with a conventional payment gateway in addition to integrating with the consumer-friendly payment gateway. It can be a hassle for merchants to integrate with multiple payment gateways and deal with differing rates, contracts, APIs, and receipt of payment methods. Indeed, many smaller and less sophisticated merchants simply to not have expertise or resources to integrate with multiple payment gateways. As such, the number of merchants that integrate with consumer-friendly payment gateways is limited. As such, individual consumers may not have the option of using their account with a consumer-friendly payment gateway to make secure payments with many merchants.

Mobile payments (such as Apple Pay) is another payment method that uses payment tokens. Mobile payments allow an individual consumer to choose whether or not they perform a secure transaction using mobile payments. Unfortunately, mobile payments also suffer from a number of drawbacks. First, mobile payments are mobile device and operating system specific. As such, a consumer has very little flexibility. If a user does not have a compatible device, they cannot perform a mobile payment. Furthermore, mobile payments work only with a point of sale device and are not valid for use with websites or native applications. Thus, even when using a compatible device, a consumer cannot use a mobile payment token to complete a transaction via a native application or web browser.

Although some conventional systems provide payment tokenization using different methods of generating payment tokens, conventional systems are typically limited to using a single payment tokenization method for all payment transactions. For example, conventional systems have a specific tokenization method based on inherent limitations of the systems. In particular, conventional systems may use a specific protocol for processing payment transactions, but also require the use of payment tokens configured in a specific way. Thus, some users may not be able to use certain payment credentials to process payment transactions via the conventional systems because the conventional systems are unable to handle the payment tokens.

Additionally, conventional systems dictate the exchange/passing of payment tokens among different components within the conventional systems. Specifically, in addition to configuring the payment tokens in a way that conforms to a specific protocol for processing payment transactions, the conventional systems pass the payment tokens and other information from one component to another based on a preset method of token exchange. As such, the conventional systems further limit payment transaction processes to a specific group of users with devices and/or operating systems that conform to the protocols associated with the conventional systems.

In summary, many conventional systems use tokenization, encryption, or merchant integration that enable secure electronic payment transactions. Such conventional systems, however, limit consumers and merchants. Accordingly, there are a number of disadvantages with conventional electronic payment systems and methods.

### SUMMARY

One or more embodiments described herein provide benefits and/or solve one or more of the foregoing or other problems in the art with systems and methods to provide flexible payment token generation and exchange. In particular, the systems and methods intelligently and dynamically determine how to process the payments on the fly. For example, one or more embodiments identify a first plurality of factors associated with a payment transaction. Based on the first plurality of factors, the systems and methods dynamically select a payment tokenization method for processing the payment transaction. The systems and methods select a payment tokenization method from a payment tokenization method from one of a network tokenization method, a gateway tokenization method, or a third party tokenization method. The systems and methods then use the selected payment tokenization method to obtain a payment token for processing the payment transaction.

Additionally, the systems and methods identify a second plurality of factors associated with the payment transaction. Based on the second plurality of factors, the systems and methods dynamically select a token exchange method for processing the payment transaction. For instance, the systems and methods select a token exchange method from one of a client-side exchange method, a server-side exchange method, or a direct exchange method. The systems and methods use the selected token exchange method to direct the payment token to a payment network, which then processes the payment transaction. By providing flexibility in the generation and exchange of payment tokens, the systems and methods provide an intelligent payment transaction process that provides the flexibility to accommodate the needs of diverse merchants and consumers.

Additional features and advantages of the embodiments will be set forth in the description that follows, and in part will be obvious from the description, or can be learned by the practice of such exemplary embodiments. The features and advantages of such embodiments can be realized and obtained by means of the instruments and combinations particularly pointed out in the appended claims. These and other features will become more fully apparent from the following description and appended claims, or can be learned by the practice of such exemplary embodiments as set forth hereinafter.

### BRIEF DESCRIPTION OF THE DRAWINGS

Various embodiments will be described and explained with additional specificity and detail through the use of the accompanying drawings in which:

FIG. 1 illustrates a schematic diagram of an example system that facilitates electronic payments in accordance with one or more embodiments;

FIGS. 2A-2C illustrate sequence-flow diagrams illustrating various methods of payment token generation as part of a payment process in accordance with one or more embodiments;

FIGS. 3A-3C illustrate sequence-flow diagrams illustrating various methods of token exchange as part of a payment process in accordance with one or more embodiments;

FIG. 4 illustrates a flow chart of a series of acts in a method of processing payment transactions with tokenized payment credentials in accordance with one or more embodiments;

FIG. 5 illustrates a detailed schematic diagram of the example system of FIG. 1 in accordance with one or more embodiments;

FIG. 6 illustrates a block diagram of an example computing device in accordance with one or more embodiments;

FIG. 7 illustrates an example network environment of a social-networking system in accordance with one or more embodiments; and

FIG. 8 illustrates an example social graph for a social-networking system in accordance with one or more embodiments.

### DETAILED DESCRIPTION

Embodiments of the present disclosure provide a payment system that provides flexible payment token generation and exchange. In particular, one or more embodiments provide a payment system that allows users to enter into payment transactions with other users or merchants. The payment system tailors a payment process for each individual payment transaction process, including which devices/systems communicate with each other and how payment information is created and passed from one device/system to another. For example, the payment system identifies a plurality of factors of a payment transaction based on the sender, recipient(s), and corresponding payment networks. The payment system uses the identified factors to determine a method for obtaining a payment token and a method for exchanging the payment token for processing the payment transaction. By dynamically determining methods of token generation and exchange, the payment system can allow a user to enter into payment transactions with other users and/or merchant systems with flexibility in processing the payment transactions.

As mentioned, the payment system allows users to initiate electronic payment transactions with other users/merchants. Specifically, the payment system receives a request to initiate an electronic payment transaction with a user or merchant from a client device associated with a sender user. For example, the payment system can allow the sender user to enter into a payment transaction to pay a merchant for goods or services or to enter into a peer-to-peer payment transaction with a recipient user via a networking system (e.g., a social networking system). To illustrate, a sender user can use a commerce application to identify goods or services provided by a merchant and purchase a product from within the commerce application. Alternatively, the sender user can enter into a peer-to-peer payment transaction to pay a recipient user from within the commerce application.

When a user requests to initiate a payment transaction from within the commerce application, the payment system identifies a plurality of factors associated with the payment transaction. The factors can include characteristics of the sender, the recipient, the payment system, a payment credential of the sender and/or of the recipient, a payment network of the recipient, and relationships between the sender, the recipient, the payment system, and the payment network. The factors can vary depending on the type of transaction, the sender/recipient(s), and the devices or software that the sender/recipient(s) use. As such, the payment system can use the identified factors to determine how to process each specific payment transaction.

In one or more embodiments, the payment system uses the plurality of factors associated with the payment transaction to select a payment tokenization method. In particular, the identified factors can provide an indication of, and can be based on, the capabilities and relationships of various aspects of the payment system, the merchant system, and/or client devices. Based on the identified factors for the payment transaction, the payment system then dynamically selects a payment token generation method. For instance, the payment system selects the payment tokenization method from one of a network tokenization method, a gateway tokenization method, or a third party tokenization method. The payment system then obtains a payment token according to the selected payment tokenization method.

Additionally, after generating a payment token according to the selected payment tokenization method, the payment system uses the plurality of factors associated with the payment transaction to select a token exchange method. Specifically, the payment system uses the identified factors to determine an optimal method of exchanging tokens for processing the payment transaction. For example, the payment system selects the token exchange method from one of a client-side exchange method, a server-side exchange method, or a direct exchange method. The payment system uses the selected token exchange method to exchange the payment token and optionally other payment information for processing the payment transaction. Using the selected token exchange method, the payment system exchanges the payment token to a client device, merchant system, or payment network for initiating and processing the payment transaction.

As mentioned, the payment system described herein provides advantages over conventional electronic payment systems. Specifically, dynamically selecting the payment tokenization method and the token exchange method provides intelligent payment processing that allows users to engage in payment transactions with a wide range of other users or merchants. For example, the dynamic selection of a payment tokenization method and a token exchange method allows users to engage in electronic payments with merchants according to each individual payment, which can be different for each user and/or corresponding payment authorization number. Performing the payment tokenization and token exchange dynamically based on the specific payment transaction speeds up payment processing time. Additionally, the flexible payment processes of the payment system provide electronic payment capabilities across platforms and for a wide array of payment methods.

As mentioned, the payment system herein provides advantages over conventional electronic payment systems. For example, many conventional systems do not process payment for merchants unless the merchants are integrated with the system, and thus, lack the flexibility to process payments for many merchants. One or more embodiments, have the flexibility to process payments for merchants that are integrated with the payment system and merchants that are not integrated with the payment system. Additionally, many conventional systems only process payment for users or consumers with a specific type of client device or operating system. One or more embodiments have the flexibility to process payments irrespective of the client device or the operating system. In summary, one or more embodiments of the payment system provide the flexibility to process payments irrespective of the sophistication of the merchant, the particular payment credential, or the client device.

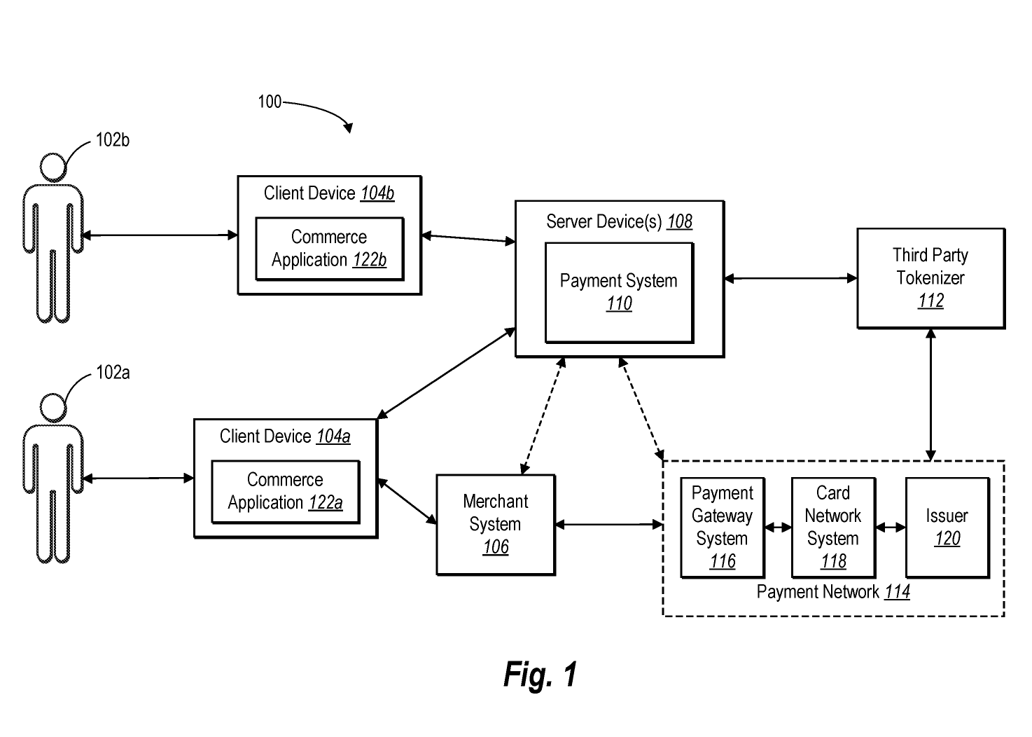

FIG. 1 is a schematic diagram illustrating an environment that includes a payment system in accordance with one or more embodiments. An overview of the environment is described in relation to FIG. 1. Thereafter, a more detailed description of the components and processes of the payment system and other components within the environment are provided in relation to the remaining figures.

As illustrated by FIG. 1, a system 100 can include a first user 102a and a second user 102b, a first client device 104a and a second client device 104b, a merchant system 106, server device(s) 108 hosting a payment system 110, a third party tokenizer 112, and a payment network 114. The system 100 can allow a first user 102a to interact with a second user 102b or with a merchant system 106 to conduct a transaction such as a peer-to-peer payment or a purchase. Specifically, the first user 102a uses the first client device 104a to enter into payment transactions with the second user 102b via the second client device 104b or with the merchant system 106. As further illustrated in FIG. 1, the first client device 104a can communicate with the server device(s) 108 hosting the payment system 110.

The payment system 110 can interact with the payment network 114, the merchant system 106, client devices 104a, 104b, and the third-party tokenizer 112 to provide increased security and flexibility for payment transactions between users and merchants. In one or more embodiments, the payment system 110 allows the first user 102a to define and enter into a payment transaction with a recipient (e.g., the second user 102b or the merchant system 106) in a payment transaction. For instance, the payment system 110 allows the first user 102a to send a payment to the recipient via the server device(s) 108 and the payment network 114. Likewise, a recipient can receive notice of the payment, accept or decline the payment, and view a payment transaction history involving the recipient. As will be explained in more detail below, the server device(s) 108 or the merchant system 106 can communicate with various components of the payment network 114 to coordinate a transaction that facilitates the payment between the first user 102a and the recipient (i.e., between their respective financial/payment accounts).

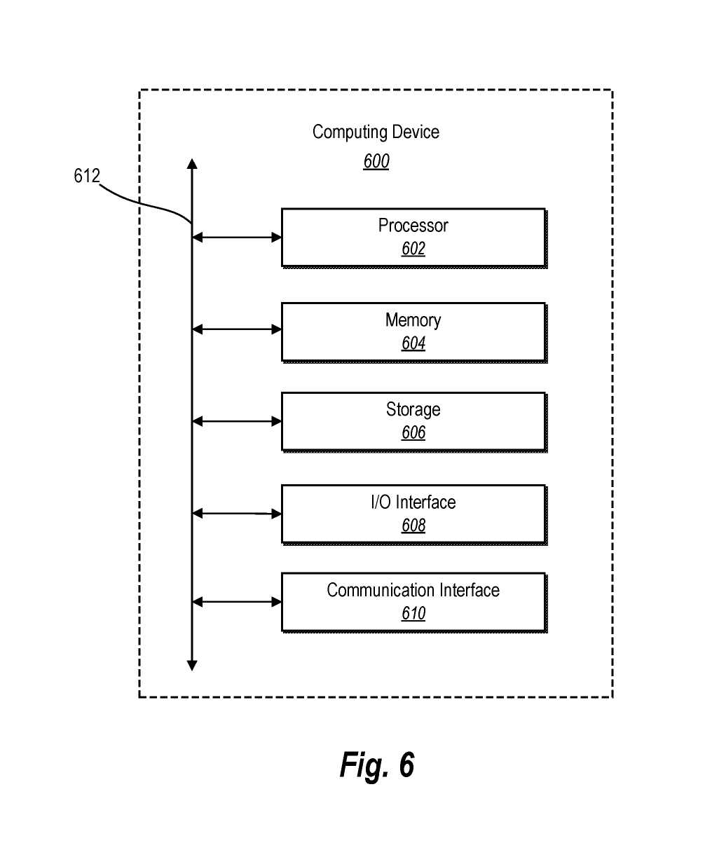

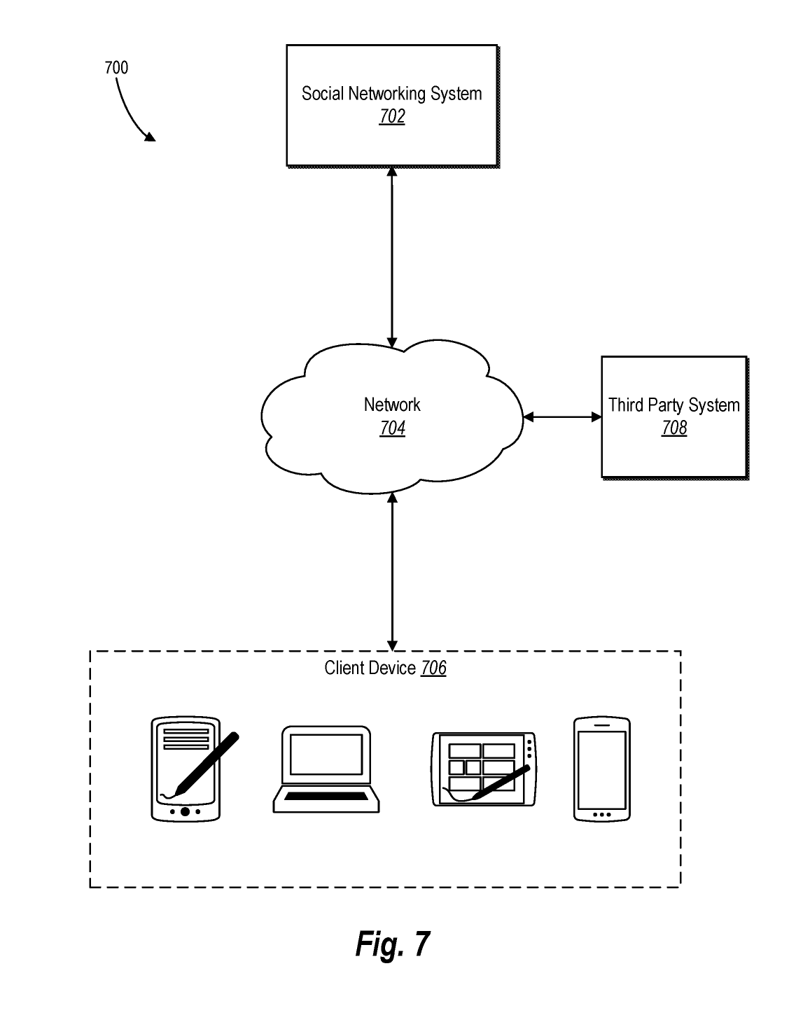

As mentioned previously, and as FIG. 1 illustrates, the first user 102a can interact with the first client device 104a. Additionally, the recipient (e.g., the second user 102a or a merchant) can interact with one or more client devices, such as the second client device 104b or a client device associated with the merchant system 106. Examples of client devices include computing devices such as mobile devices (e.g., smartphones, tables), laptops, desktops, or any other type of computing device. FIG. 6 and the corresponding description provide additional information regarding computing devices. Moreover, and as mentioned above, the first client device 104a can communicate with the second client device 104b or the merchant system 106 through a network. In one or more embodiments, the network includes the Internet or World Wide Web. The network, however, can include one or more private and/or public networks that use various communication technologies and protocols, as further described below with reference to FIG. 7.

The payment system 110 coordinates the sending and receiving of payments between the first user 102a and the recipient in connection with a payment transaction. For example, the first user 102a can select a product or service to purchase via a commerce application 122a or web interface and compose and send a request to initiate a payment transaction to the server device(s) 108 in connection with the product/service purchase. Alternatively, the first user 102b can use a commerce application 122b to send a peer-to-peer payment to the second user 102b. To illustrate, the first user 102a can provide input via the commerce application 122a of the first client device 104a to define the payment method (e.g., the user's credit card, debit card, or gift card), payment amount, payment currency, payment description, and/or various other payment details. In at least some implementations, the first client device 104a can allow the first user 102a to compose and send messages to the recipient via the server device(s) 108.

As used herein, the term “commerce application” refers to an application that allows a sender user to transfer funds to a recipient via one or more payment methods. For example, a commerce application can allow a sender user to initiate a peer-to-peer payment transaction with a recipient user. Additionally, a commerce application can allow a sender user to initiate a payment transaction with a merchant to purchase goods or services offered by the merchant. The commerce application can also include, or be part of and application that includes, messaging capabilities to allow a sender user to communicate with a recipient.

In one or more embodiments, the payment system 110 coordinates a payment transaction between one or more accounts of the first user 102a and one or more accounts of the recipient via the payment network 114. For example, in response to receiving a payment message from the user 102, the server device(s) 108 can communicate with the payment network 114 to obtain and provide payment information to process a payment using one or more components within the payment network 114, as described in more detail below. Alternatively, or additionally, the payment system 110 can maintain one or more user accounts directly, and therefore, the payment system 110 can coordinate a transaction, or a portion of a transaction.

As illustrated in FIG. 1, the payment network 114 includes a payment gateway system 116, a card network system 118, and an issuer of a payment authorization number (e.g., issuer 120). In other embodiments, the payment network 114 includes more or fewer actors. Additionally, although FIG. 1 illustrates a particular arrangement of the first user 102a, the second user 102b, the first client device 104a, the second client device 104b, the merchant system 106, the payment system 110, the third party tokenizer 112, and the payment network 114, various additional arrangements are possible. Furthermore, the payment network 114 can include a plurality of payment gateway systems, card network systems, and card issuers, which may correspond to different merchant systems or users, though FIG. 1 illustrates only a single payment gateway system 116, card network system 118, and issuer 120 for simplicity in description.

As used herein, the terms “card issuer” and “issuer” refer to a financial institution (e.g., a bank) that issues credit cards or debit cards to consumers and services their accounts. Issuers can also be, or can communicate with, a card network system or a payment gateway system. Some example of card issuers include CHASE, BANK OF AMERICA, WELLS FARGO, U.S. BANK, and CITIBANK. Examples of card network systems include VISA, DISCOVER, and MASTERCARD.

As used herein, the term “payment authorization number” refers to a number that authorizes access to the corresponding payment account. For example, a payment authorization number can be a credit card number or debit card number.

As used herein, the term “payment gateway system” refers to software and servers that transmit transaction information to acquiring banks and responses from issuing banks (such as whether a transaction is approved or declined). Thus, a payment gateway system facilitates communication between banks. Furthermore, payment gateway implement Payment card Industry Data Security Standard (PCI-DSS or PCI). Payment gateway systems help bridge communication protocols and provide security on behalf of a merchant. Payment gateway systems usually charge a per transaction fee. Some example of payment gateway systems include Braintree, Dwolla, Paypal, Authorize.net.

As used herein, the term “issuer” refers to a financial institution (e.g., a bank) that issues credit cards to consumers and services their accounts. Issuers can also be a card network system or a payment gateway system. Some example of card network systems include CHASE, BANK OF AMERICA, WELLS FARGO, U.S. BANK, and CITIBANK.

The payment network can include more or fewer components as may serve a particular embodiment. Specifically, various embodiments of the payment network 114 also include one or more components for processing payment transactions between users and merchants. For instance, the payment network 114 can include components for communicating with the client devices 104a, 104b, the merchant system 106, the server device(s) 108, and the third party tokenizer 114, as well as payment processing components such as bank systems associated with the users and merchants and components for communicating with the bank systems.

In one or more embodiments, the payment system 110 communicates with the payment network 114 to begin the payment transaction process. In one or more embodiments, the payment system 110 communicates with the payment gateway system 116, the card network system 118 associated with a payment authorization number of the user, or the third party tokenizer to obtain a payment token (e.g., a gateway payment token, a network payment token, or a third party token). Specifically, the payment system 110 dynamically determines a method of obtaining a payment token based on various factors associated with the payment transaction. Thus, the payment system 110 can select from a plurality of different payment tokenization methods to tailor the payment tokenization according to each individual payment transaction.

As used herein, the term “payment token” refers to a tokenized version of a payment authorization number. Specifically, a payment token can include a hashed or otherwise obfuscated version of the payment authorization number that includes a plurality of characters that the payment gateway system 116 or the card network system 118 maps to the particular payment authorization number for gateway tokens or network tokens, respectively. The payment network 114 can then return the payment token to the payment system 110. As such, the payment system 110 can select as the payment tokenization method a network tokenization method or a gateway tokenization method.

Alternatively, a payment token can include an obfuscated version of a temporary payment authorization number from a third party tokenizer. In particular, the payment system 110 can select a third party tokenization method in which a third party tokenizer 112 acts as an intermediary between the card network system 118 associated with the first user 102a and a payment gateway system associated with the recipient. The payment system 110 can communicate with the third party tokenizer 112 to obtain a third party payment token. The third party tokenizer 112 can communicate with the card network system 118 to charge a payment credential of the first user 102a for a payment amount of the payment transaction, and establish a temporary payment account for the payment transaction. Additionally, the third party tokenizer 112 can generate and return a payment token representing a payment authorization number of the temporary payment account.

Once the payment system 110 receives the payment token from the payment network 114 or third party tokenizer 112, the server device(s) 108 then dynamically select a token exchange method for processing the payment transaction. Specifically, the payment system 110 exchanges the payment token and payment information with various components of the system 100 based on based on various factors associated with the payment transaction. The payment system can select from a plurality of different token exchange methods to tailor the token exchange according to each individual payment transaction. Thus, the payment system 110 can communicate with one or more components in the system 100 to exchange the payment token to process the payment transaction based on the factors associated with the payment transaction.

For instance, a token exchange method can include a client-side exchange method, a server-side exchange method, or a direct exchange method. The client-side exchange method can include the payment system 110 communicating with the first client device 104a to exchange the payment token. The payment system 110 can send the payment token to the first client device 104a, which passes the payment token to the merchant system 106 for the merchant system 106 to use in initiating the payment transaction with a payment gateway system 116 associated with the merchant system 106. In the client-side exchange method, the payment system 110 may not communicate with the merchant system 106.

The server-side exchange method can include the payment system 110 communicating with the merchant system 106 to exchange the payment token. For example, the merchant system 106 can integrate with the payment system 110 to allow the payment system 110 to communicate directly (e.g., to pass the payment token) with the merchant system 106 during a payment transaction. Specifically, the merchant system 106 can integrate with the payment system 110 by registering a merchant account or establishing a formal/contractual relationship with the payment system 110, establishing a merchant page with the payment system 110, or encoding API calls in a merchant site that causes the merchant system 106 and payment system 110 to pass information associated with payment transactions.

The direct exchange method can include the payment system 110 directly communicating payment information to the payment gateway system 116. For instance, the payment system 110 can act on behalf of the merchant system 106 to provide a payment token and payment information to initiate a payment transaction. The payment gateway system 116 can then process the payment transaction as if the merchant system 106 had initiated the payment transaction.

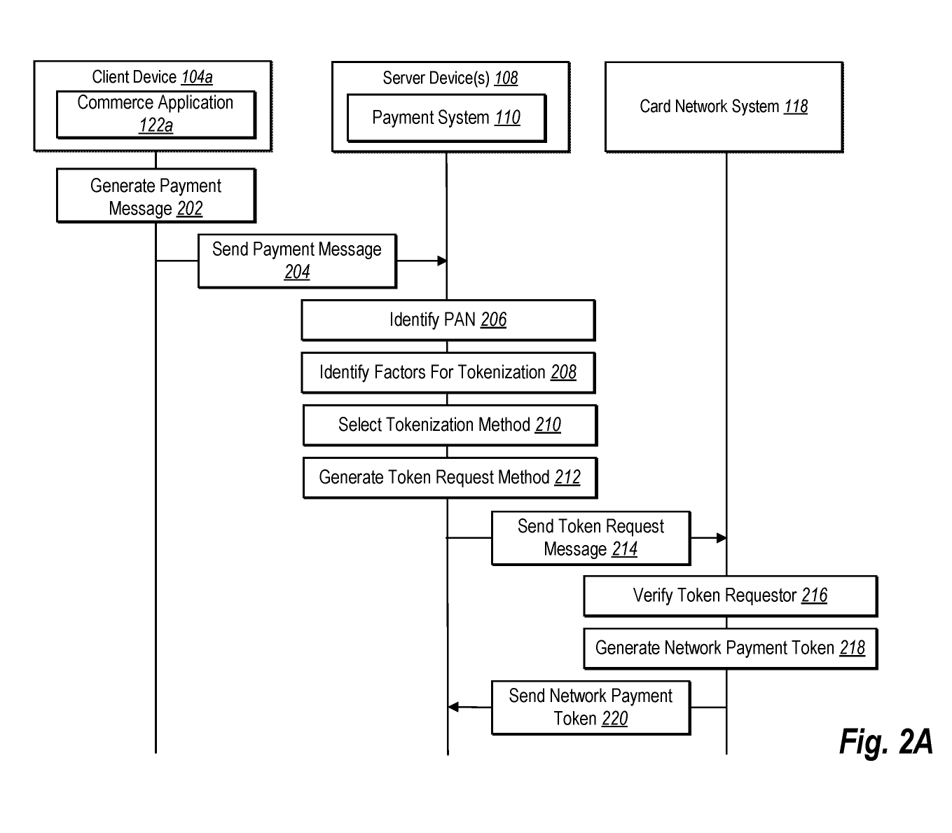

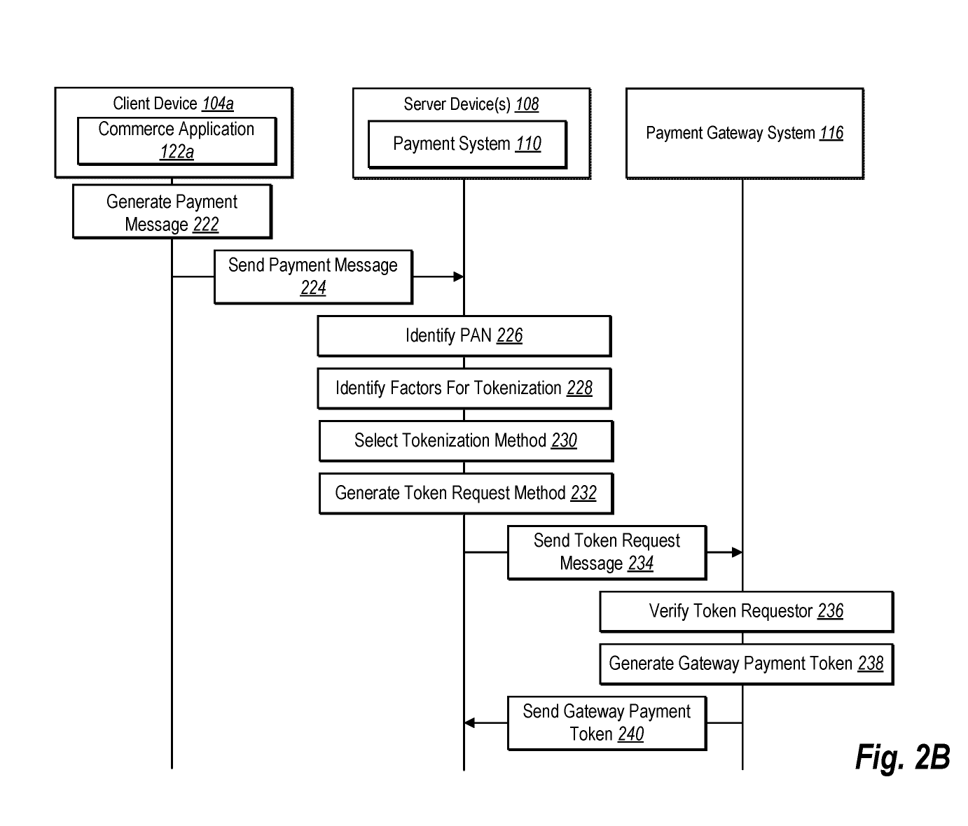

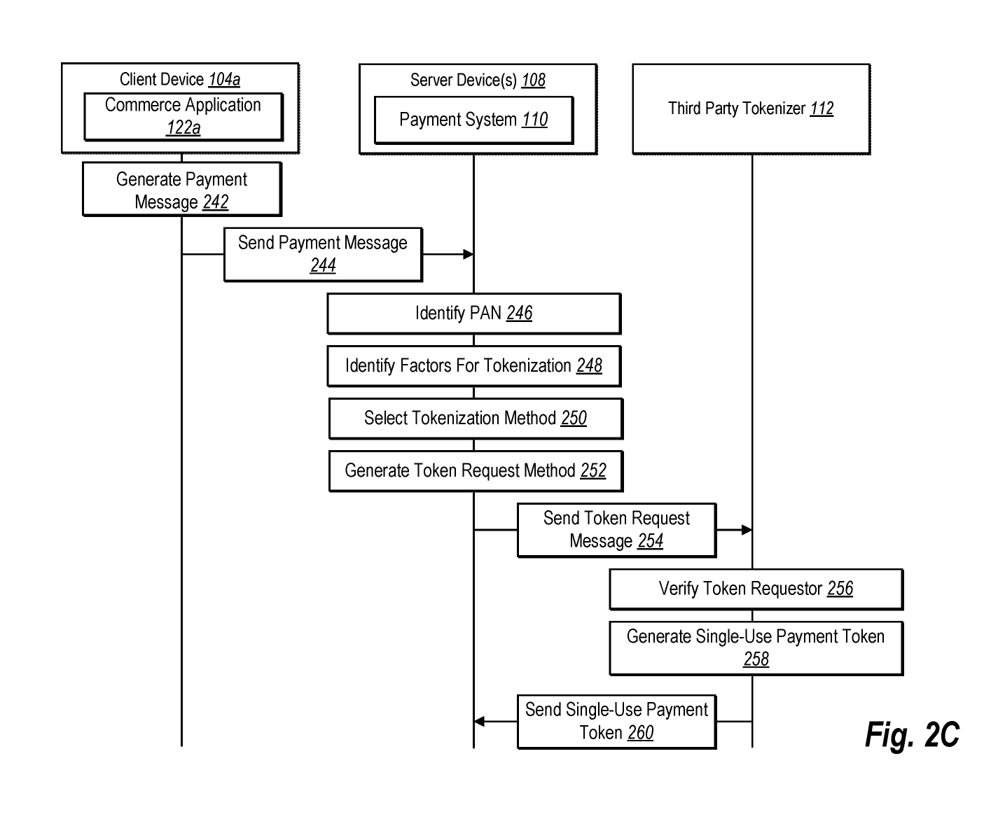

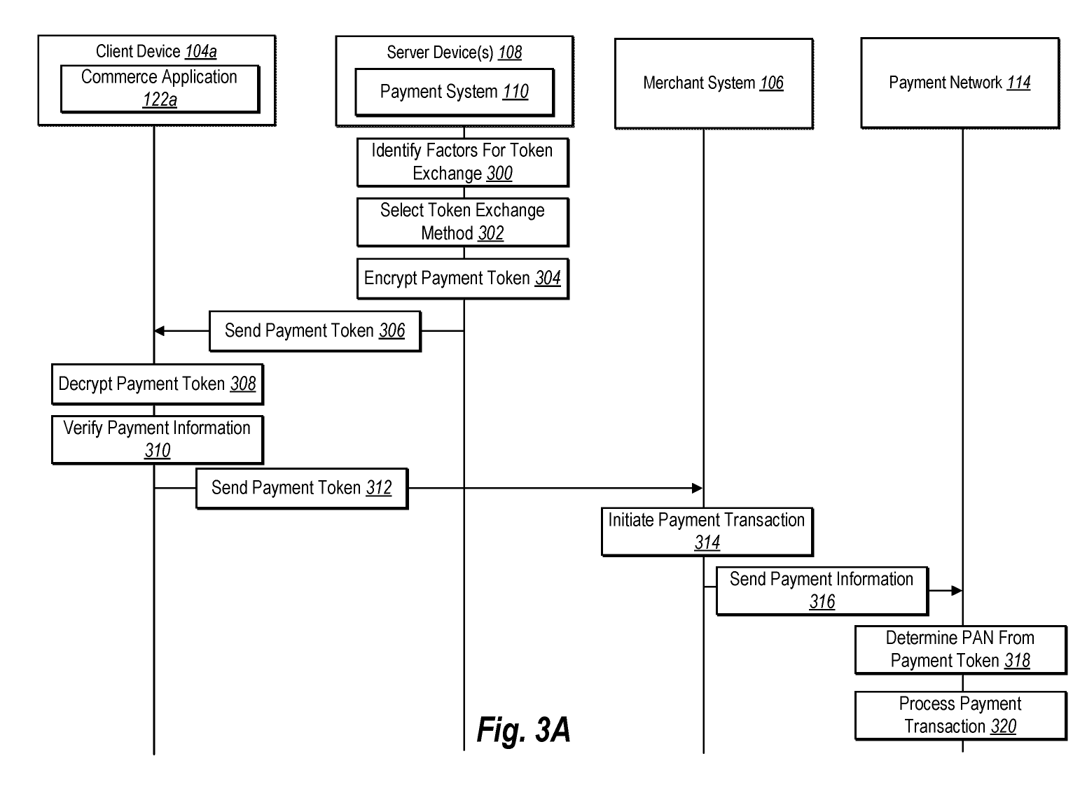

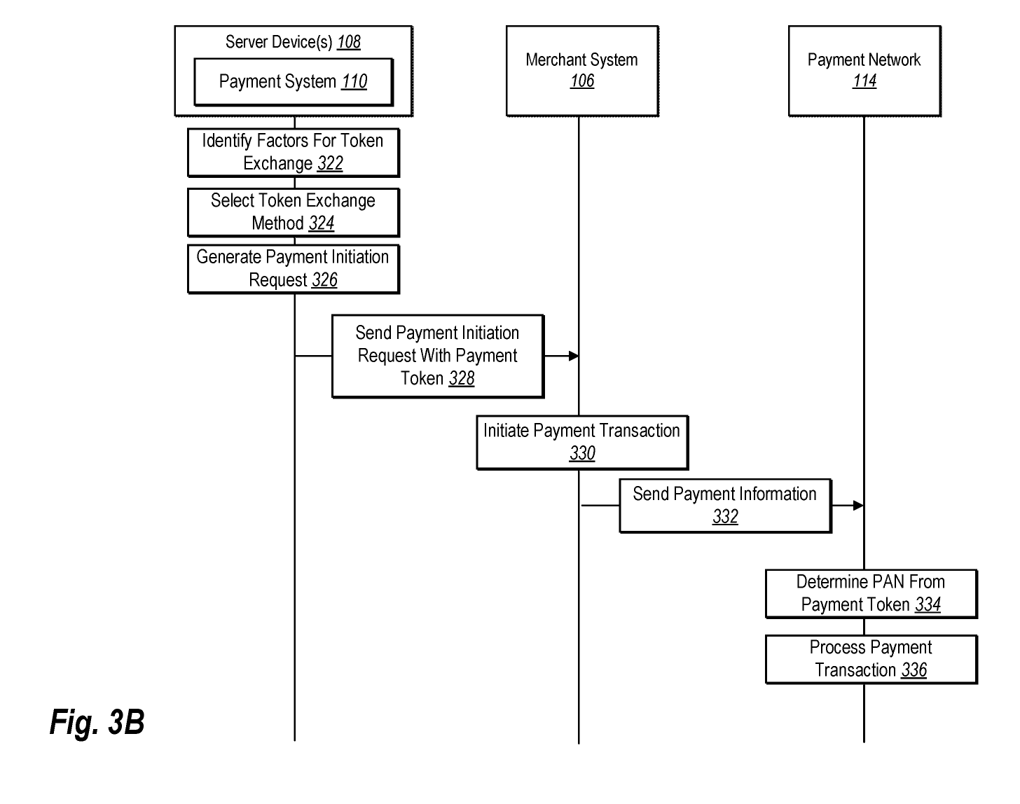

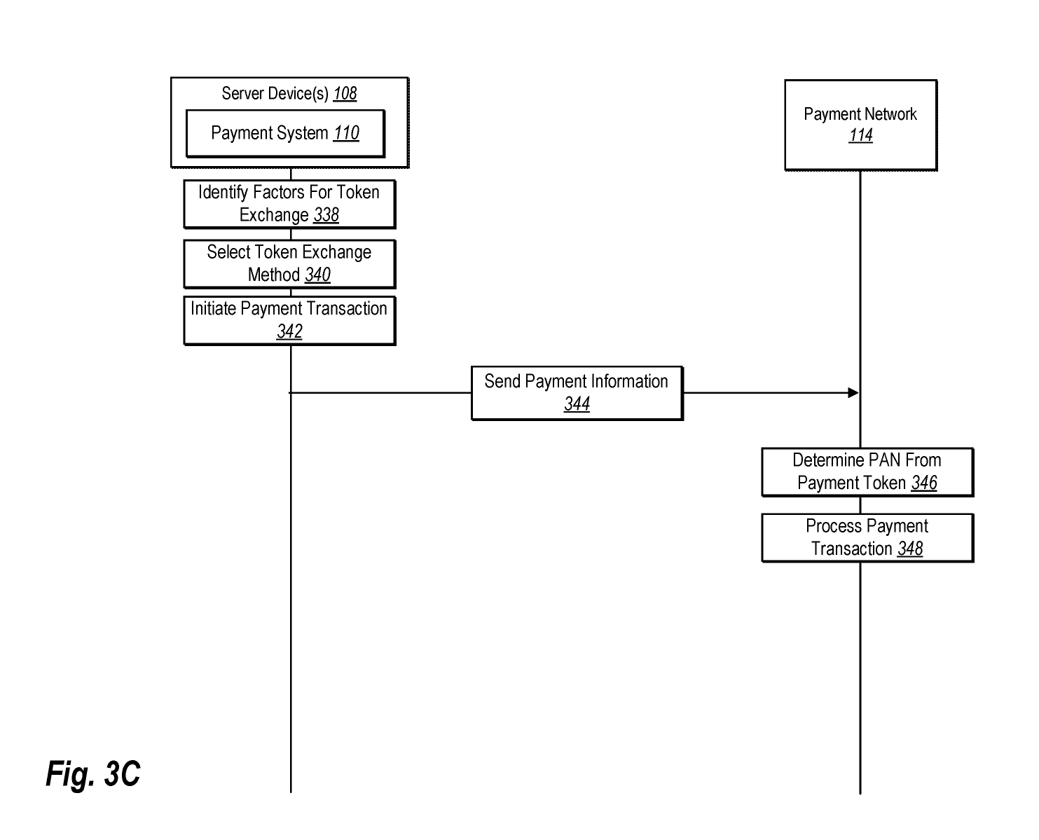

As described above, the payment system 110 provides flexibility for processing payment transactions with varying factors. For example, the payment system 110 can provide tailored transactions for any combination of small sellers, large sellers, different payment credentials, users, issuing banks, etc. Such flexibility is advantageous in allowing users and merchants to engage in payment transactions across a variety of platforms and devices, thereby increasing the availability of electronic payment transactions to a large audience. As mentioned, the payment system 110 provides the flexibility by dynamically selecting payment tokenization methods and token exchange methods for each payment transaction. As follows, FIGS. 2A-2C illustrate process diagrams for processing payment transactions via a plurality of payment tokenization methods. Additionally, FIGS. 3A-3C illustrate process diagrams for processing payment transactions via a plurality of token exchange methods. Consistent with payment system illustrated in FIG. 1, FIGS. 2A-2C and FIGS. 3A-3C illustrate (according to a sequence flow of operations) varying combinations of a first client device 104a, a merchant system 106, server device(s) 108, a third party tokenizer 112, and a payment network 114 (including the payment gateway system 116, and the card network system 118).

FIG. 2A illustrates a process diagram of dynamically selecting a network tokenization method. Specifically, the network tokenization method includes tokenizing a payment authorization number at a card network system associated with the payment authorization number. In one or more embodiments, a process for processing a payment transaction between a user and a recipient can begin with the first client device 104a generating a payment message 202 in response to the user sending a request to initiate the payment transaction with a recipient. For example, the user can initiate the payment transaction with a merchant or another user within the commerce application 122a on the first client device 104a. To illustrate, the user can purchase a product offered by the merchant within the commerce application 122a. Alternatively, the user can initiate a peer-to-peer payment transaction within the commerce application 122a.

Generating the payment message can include identifying payment information for the payment transaction between the user and a recipient. For example, the payment message can include a user identifier, a recipient identifier, a payment amount, a payment authorization number (or an indication of a payment method with a corresponding payment authorization number), product details, and/or other information that allows the server device(s) 108 to begin the payment transaction process. According to various examples, the first client device 104a can obtain payment information for the payment message from interactions between the user and recipient, a data manager on the first client device 104a, and/or from user input.

The first client device 104a then sends the payment message 204 to the payment system 110 at the server device(s) 108. For example, the commerce application 122a on the first client device 104a can communicate with the payment system 110 using a communication protocol capable of transmitting information securely. To illustrate, the commerce application 122a can cause the first client device 104a to establish a secure communication channel with the server device(s) 108 and send the payment message via the secure communication channel.

In response to receiving the payment message from the first client device 104a, the payment system 110 identifies a payment authorization number 206 for the user. In particular, the payment system 110 identifies the payment authorization number from the payment message. As mentioned, the payment authorization number can be a credit card number, debit card number or other account number associated with a payment account of the user. The payment system 110 also identifies additional payment information included in the payment message, such as information from a user account of the user.

Additionally, the payment system 110 identifies a plurality of factors for tokenization 208 of the payment authorization number in connection with the payment transaction. Specifically, the payment system 110 identifies details associated with the user, the recipient, and the payment transaction as factors for tokenization. The plurality of factors associated with the payment transaction depend on the type of transaction and the participants. For example, a payment transaction between the user and a merchant can include different factors than a payment transaction between the user and a peer user. To illustrate, the factors can include, but are not limited to a payment credential of the user, a payment credential of the recipient, a payment gateway system associated with the recipient, a card network system associated with a payment authorization number of the user, and a risk level associated with the payment transaction.

According to one or more embodiments, the payment system 110 determines whether the payment authorization number of the user is tokenizable by the card network system 118. For example, the payment system 110 can identify the card network system 118 based on the payment authorization number associated with the payment transaction and determine whether the payment authorization number is tokenizable by the card network system 118. Additionally, the payment system 110 can use an identity of the user to determine whether the payment authorization number is tokenizable by the card network system 118, such as by accessing a payment history associated with the user and/or payment authorization number.

In one or more embodiments, the payment system 110 identifies at least one attribute of the payment authorization number, such as the card type or consumer enrollment, based on one or more digits in the payment authorization number (e.g., based on a bank identification number). The payment system 110 can then determine whether the card network system 118 associated with the payment authorization number provides network payment tokens for the payment authorization number based on the identified attribute(s) of the payment authorization number. For example, the payment system 110 can determine that certain card network systems 118 provide network payment tokens, while other card network systems 118 do not. Similarly, certain card types or payment authorization tokens from a card network system 118 may be tokenized, while others associated with the same card network system 118 may not be tokenized.

Furthermore, the payment system 110 can determine a risk level for a sender or a recipient of a payment transaction. In particular, the risk level can indicate whether a payment transaction is potentially fraudulent based on information associated with the sender/recipient. For example, the payment system 110 can determine that the sender or the recipient is a fraudster based on a payment transaction history or information associated with a user account of the sender or recipient. Based on the risk level, the payment system 110 can allow the payment transaction, disallow the payment transaction, or select a particular payment tokenization method for the payment transaction.

After identifying the factors for tokenization, the payment system 110 selects the tokenization method 210 for the payment transaction. Specifically, if the payment authorization number is tokenizable by the card network system 118, the payment system 110 can select the network tokenization method. Alternatively, if the payment authorization number is not tokenizable by the card network system 118, or the payment system 110 determines that another payment tokenization method is faster or more optimal for the payment transaction, the payment system 110 can select another payment tokenization method described in FIGS. 2B-2C.

The payment system 110 uses the payment information included in the payment message from the first client device 104a to generate a token request message 212. Specifically, the payment system 110 generates a token request message to request a network payment token associated with the identified payment authorization number. The token request message includes the payment authorization number and identification information that allows the card network system 118 to verify the identity of the user and/or the token requestor (i.e., the payment system 110). The payment system 110 requests the card network system 118 to provide the network payment token for use in processing payment transactions for the user, rather than using the payment authorization number.

In one or more embodiments, identification information included in the token request message includes a token requestor identifier. For example, the token requestor identifier can be a unique identifier that the card network system 118 previously assigned to the payment system 110. To illustrate, the token requestor identifier may be a fixed length value of 12 characters. The token requestor identifier is an identifier that allows the card network system 118 to determine an identity of the token requestor from the token request message.

The payment system 110 sends the token request message 214 to the card network system 118 corresponding to the payment authorization token. Upon receipt of the token request message, the card network system 118 identifies the payment authorization number from the token request message and verifies the authenticity of the payment authorization number. For example, the card network system 118 identifies the payment authorization number in a database of payment authorization numbers associated with the card network system 118. Additionally, the card network system 118 can identify additional information associated with the payment authorization number, such as an identity of the user, security information associated with the user, and payment transaction information from the token request message, as provided by the payment system 110.

In one or more embodiments, the card network system 118 verifies the token requestor 216 using the token requestor identifier in the token request message. The identity of the token requestor allows the card network system 118 to identify a trust level established between the card network system 118 and the payment system 108. Specifically, the card network system 118 may establish trust relationships with one or more token requestors. For example, each trusted token requestor may request network payment tokens from the card network system 118 without requiring additional security information.

If another entity that is not trusted by the card network system 118 attempts to request a network payment token from the card network system 118, the card network system 118 may reject the request. By establishing trust relationships with token requestors and providing tokens only to trusted requestors, the card network system 118 may reduce the risk of fraudulent requests for network payment tokens. Additionally, the use of trusted requestors allows the card network system 118 to reduce the amount of identification information that the consumer must provide to authorize payment transactions. In alternative embodiments, the card network system 118 requests additional security information to verify the authenticity of requests from untrusted requestors.

Once the identity of the payment system 110 is verified, the card network system 118 then generates a network payment token 218 for the payment authorization number. In particular, the card network system 118 generates a network payment token that represents the payment authorization number to entities associated with the payment transaction process. For example, the network payment token can be a numerical value with a variable number of digits within a predetermined number of digits (e.g., a variable field of up to 19 digits).

In one or more embodiments, the network payment token has the same number of digits as the payment authorization number so that each entity associated with the payment transaction process sees the network payment token as a valid payment authorization number. Specifically, the network payment token may have a similar or same bank identification number and similar numbering logic as the original payment authorization number. Alternatively, the number of digits may not be based on the payment authorization number, such that the network payment token may have a different number of digits than the payment authorization number.

Additionally, the card network system 118 can generate a cryptogram for the payment transaction. For instance, the cryptogram can be a single-use code or value that ties or scopes the network payment token to the current payment transaction. The cryptogram allows the card network system 118 to verify that the network payment token has been authorized for use with the current payment transaction. As such, the card network system 118 denies requests to process payment transactions without a cryptogram.

As used herein the term “cryptogram” refers to a code assigns to the payment transaction for use in authorizing use of the payment token for the payment transaction. To illustrate, a cryptogram can be a numeric code or other value that allows the card network system 118 to validate the use of the payment token for the corresponding payment transaction. In one or more embodiments, a cryptogram is a single use cryptogram that is valid for a single transaction, transaction amount, etc.

The card network system 118 then sends the network payment token 220 with the cryptogram to the payment system 110. According to one or more embodiments, the payment system 110 associates and stores the network payment token with a user profile or user account of the user. As described in more detail below, once the payment system 110 has received a network payment token for the user, future payment transactions involving the corresponding payment authorization number for the user can use the stored network payment token instead of the payment authorization number.

When processing a payment transaction with a network payment token, the card network system 118 receives the network payment token in connection with the payment transaction. The card network system 118 then determines the payment authorization number corresponding to the network payment token based on the mapping previously established between the network payment token and the payment authorization number. The card network system 118 can then process the payment transaction using the recovered payment authorization number by providing the payment authorization number to the corresponding issuer to fund the payment transaction.

FIG. 2B illustrates a process diagram of dynamically selecting a gateway tokenization method. In particular, selecting the gateway tokenization method includes tokenizing a payment authorization number at a payment gateway system associated with the recipient. As described herein, the gateway tokenization method includes at least some operations or steps that are different from the network tokenization method and/or the third party tokenization method. The gateway tokenization method can also include at least some operations or steps that are the same as the network tokenization method or the third party tokenization method. Additionally, process steps in FIG. 2B that are similar to process steps in FIG. 2A or FIG. 2C can involve the same, fewer, or additional operations to the corresponding process steps in FIG. 2A or FIG. 2C.

As described above in relation to FIG. 2A, a process for processing a payment transaction between a user and a recipient can begin with the first client device 104a generating a payment message 222 in response to the user sending a request to initiate the payment transaction with a recipient. For example, the user can initiate the payment transaction with a merchant to purchase a product from the merchant via the commerce application 122a. The payment message includes payment information for processing the payment transaction, such as identities of the sender and recipient, payment amount, and other information.

After generating the payment message, the first client device 104a sends the payment message 224 to the payment system 110 at the server device(s) 108. In response to receiving the payment message from the first client device 104a, the payment system 110 identifies a payment authorization number 226 for the user in connection with the payment transaction. In particular, the payment system 110 identifies the payment authorization number from the payment message. For example, the payment system 110 identifies the payment authorization number based on a selected payment method (e.g., credit card or debit card) associated with the payment transaction.

After identifying the payment authorization number, the payment system 110 identifies a plurality of factors for tokenization 228 of the payment authorization number in connection with the payment transaction. For instance, the payment system 110 identifies details associated with the payment transaction as previously mentioned. According to the gateway tokenization method, the payment system 110 can identify one or more factors that indicate that the payment authorization number is tokenizable at the payment gateway system 116 of the payment network 114 illustrated in FIG. 1.

In one or more embodiments, the payment system 110 determines whether a recipient (e.g., a merchant system) of the payment transaction is associated with a payment gateway system 116 that allows gateway tokenization. Additionally, the payment system 110 can determine that the payment system 110 has access to the payment gateway system 116 to make requests on behalf of the recipient. For example, the payment system 110 can integrate with, or gain access to, the payment gateway system 116 by receiving permission from the recipient directly or indirectly. To illustrate, the payment system 110 can receive information from the recipient or within the payment message that identifies the payment gateway system 116 to allow the payment system 110 to communicate directly with the payment gateway system 116.

To illustrate, the payment system 110 can obtain a payment gateway identifier that indicates which payment gateway system is to be used to process charge requests for the commerce application 122a or recipient. Additionally, the payment system 110 can access an application identifier (or merchant identifier, or account identifier) to be used when interacting with the identified payment gateway system 116 to identify which account is to be credited with the funds from the user. In one or more embodiments, the payment system 110 receives the payment gateway identifier and/or the application identifier from the recipient (e.g., from a merchant system). In one or more embodiments, the payment system 110 identifies the payment gateway system 116 based either in part or exclusively upon information from within the payment message from the first client device 104a.

After identifying the plurality of factors (obtaining identifying information associated with the gateway payment system 116, identifying risk level, etc.), the payment system 110 selects the tokenization method 230 for the payment transaction. Specifically, if the payment system 110 obtains authorization to access the payment gateway system 116, including identifying information for the payment gateway system 116 and the recipient, the payment system 110 can select the gateway tokenization method. Alternatively, if the payment system 110 does not have authorization to access the payment gateway system 116, or the payment system 110 determines that another payment tokenization method is faster or more optimal for the payment transaction, the payment system 110 can select another payment tokenization method.

The payment system 110 uses the payment information included in the payment message from the first client device 104a to generate a token request message 232. Specifically, the payment system 110 generates a token request message to request a gateway payment token associated with the identified payment authorization number. The token request message includes the payment authorization number and identification information that allows the gateway payment system 116 to verify that the payment system 110 is authorized to make a request for a gateway payment token. The payment system 110 sends the token request message 234 to the payment gateway system 116 to provide the gateway payment token for use in processing the payment transaction, rather than using the payment authorization number.

In response to receiving the token request message, the payment gateway system 116 identifies the payment authorization number from the token request message and verifies the authenticity of the payment authorization number. For instance, the payment gateway system 116 can identify the payment authorization number in a database of payment authorization numbers associated with a plurality of different users. Alternatively, the payment gateway system 116 can send a request to a card network system associated with the payment authorization number to verify the authenticity of the payment authorization number. If the payment gateway system 116 receives a response indicating that the payment authorization number is authentic (for the user), the payment gateway system 116 determines that the payment authorization number is available for tokenization.

In one or more embodiments, the payment gateway system 116 verifies the token requestor 236 based on an identifier in the token request message. For example, the payment system 110 can include a token requestor identifier, an application identifier, or a payment gateway identifier in the token request message. In response to detecting a specified identifier in the token request message, the payment gateway system 116 can verify the identity or trust level of the token requestor. If the payment gateway system 116 is unable to verify the identity of the token requestor, the payment gateway system 116 can deny the request.

After verifying the identity of the payment system 110, the payment gateway system 116 then generates a gateway payment token 238 for the payment authorization number. In particular, the payment gateway system 116 generates a gateway payment token that represents the payment authorization number to entities associated with the payment transaction process. For example, the gateway payment token can be a numerical value with a variable number of digits within a predetermined number of digits. Additionally, the gateway payment token can include the same number of digits as the payment authorization number so that each entity associated with the payment transaction process sees the gateway payment token as a valid payment authorization number, as described above with respect to the network payment token.

The payment gateway system 116 can also generate a cryptogram for the payment transaction. Specifically, the payment gateway system 116 can tie the cryptogram to the payment transaction so that the cryptogram is a single-use code or value that only works with the current payment transaction. The cryptogram can allow the gateway payment system 116 to verify that the gateway payment token has been authorized for use with the current payment transaction. The gateway payment system 116 denies requests to process payment transactions without a cryptogram.

The gateway payment system 116 then sends the gateway payment token 240 with the cryptogram to the payment system 110. According to one or more embodiments, the payment system 110 associates and stores the gateway payment token with a user profile or user account of the user. As described in more detail below, once the payment system 110 has received a gateway payment token for the user, future payment transactions involving the corresponding payment authorization number for the user can use the stored gateway payment token instead of the payment authorization number.

When processing a payment transaction with a gateway payment token, the gateway payment system 116 receives the gateway payment token in connection with the payment transaction. The gateway payment system 116 then determines the payment authorization number corresponding to the gateway payment token based on the mapping previously established between the gateway payment token and the payment authorization number. The gateway payment system 116 can then process the payment transaction using the recovered payment authorization number by providing the payment authorization number to the corresponding card network system, which passes it to the corresponding issuer to fund the payment transaction.

FIG. 2C illustrates a process diagram of dynamically selecting a third party tokenization method. In particular, selecting the third party tokenization method includes tokenizing a payment authorization number at a third party system. As described herein, the third party tokenization method includes at least some operations or steps that are different from the network tokenization method and/or the gateway tokenization method. The third party tokenization method can also include at least some operations or steps that are the same as the network tokenization method and/or the gateway tokenization method. Additionally, process steps in FIG. 2C that are similar to process steps in FIG. 2A or FIG. 2B can involve the same, fewer, or additional operations to the corresponding process steps in FIG. 2A or FIG. 2B.

As described previously, a process for processing a payment transaction between a user and a recipient can begin with the first client device 104a generating a payment message 242 in response to the user sending a request to initiate the payment transaction with a recipient. For example, the user can initiate the payment transaction with another user or a merchant within the commerce application 122a. The payment message includes payment information for processing the payment transaction, such as identities of the sender and recipient, payment amount, and other information.

In response to generating the payment message, the first client device 104a sends the payment message 244 to the payment system 110. The payment system 110 then identifies a payment authorization number for the user in connection with the payment transaction. Specifically, the payment system 110 identifies the payment authorization number 246 from the payment message. For example, the payment system 110 identifies the payment authorization number based on a selected payment method (e.g., credit card or debit card) associated with the payment transaction.

After identifying the payment authorization number, the payment system 110 identifies a plurality of factors for tokenization 248 of the payment authorization number in connection with the payment transaction. For instance, the payment system 110 identifies details associated with the payment transaction as previously mentioned. According to the third party tokenization method, the payment system 110 can identify one or more factors that indicate that the payment authorization number is not tokenizable at a payment gateway system 116 or a card network system 118 of the payment network 114 illustrated in FIG. 1. Alternatively, the payment system 110 can determine that the third party tokenization method provides advantages over other tokenization methods for the current payment transaction, such as speed of processing the payment transaction.

In one or more embodiments, the payment system 110 also identifies a risk level associated with the payment transaction as a factor for selecting the payment tokenization method. As previously mentioned, the payment system 110 can determine a risk level for the user and/or the recipient. The payment system 110 can compare the risk level to a predetermined threshold to determine whether the payment transaction is likely fraudulent (e.g., the user or the recipient) is a fraudster. If the risk level is above the threshold, a third party token can provide additional risk mitigation for the sender or recipient.

The payment system 110 can then select the payment tokenization method 250 for processing the payment transaction. Specifically, the payment system 110 selects the third party tokenization method. In one or more embodiments, the payment system 110 selects the third party tokenization method if the third party tokenization is faster or otherwise more efficient for processing the payment transaction given the plurality of factors associated with the payment transaction. Alternatively, the payment system 110 can select the third party tokenization method if the network tokenization method and/or the gateway system tokenization method are not available.

The payment system 110 then generates a token request message 252 to request a third party payment token associated with the payment authorization number for the payment transaction. Specifically, the token request message includes the payment authorization number and identification information that allows the third party tokenizer 112 to verify the identity of the user and/or the token requestor (i.e., the payment system 110). The payment system 110 requests the third party tokenizer 112 to provide the third party payment token for use in processing payment transactions for the user, rather than using the payment authorization number. Additionally, the payment system 110 can maintain relationships with a plurality of third party tokenizers 112 to use in different payment transactions, such as with different card network systems or payment gateway systems.

The payment system 110 then sends the token request message 254 to the third party tokenizer 112. In one or more embodiments, in response to receiving the token request message, the third party tokenizer 112 verifies the token requestor 256 based on the identification information in the token request message. For example, the token request message can include a token requestor identifier that indicates the payment system 110 is a verified token requestor. In response to detecting a specified identifier in the token request message, the third party tokenizer 112 can verify the identity or trust level of the token requestor. If the third party tokenizer 112 is unable to verify the identity of the token requestor, the third party tokenizer 112 can deny the request.

After verifying the identity of the payment system 110, the third party tokenizer 112 generates a third party payment token 258 for the payment authorization number. In particular, the third party tokenizer 112 generates a temporary account for the payment authorization number. The temporary account is associated with a temporary payment authorization number for the current payment transaction. The third party tokenizer 112 sends a request to a card network system associated with the payment authorization number and initiates a fund transfer for the payment amount of the payment transaction from a payment credential corresponding to the payment authorization number to the temporary account.

After crediting the temporary account with funds from the user's payment credential, or after receiving a response from the card network system that the fund transfer was initiated successfully, the third party tokenizer can then use the temporary account for the current payment transaction. Specifically, the third party tokenizer 112 uses the temporary payment authorization number for tokenizing in connection with the payment transaction. For example, the third party tokenizer 112 can generate a third party payment token for the temporary payment authorization number by mapping the temporary payment authorization number to a value associated with the third party payment token. The third party tokenizer 112 sends the third party payment token 260 to the payment system 110.

When processing a payment transaction with a third party payment token, the third party tokenizer 112 receives the third party payment token in connection with the payment transaction. The third party tokenizer 112 determines the temporary payment authorization number corresponding to the third party payment token based on the mapping previously established between the third party payment token and the payment authorization number. The third party tokenizer 112 can then process the payment transaction the temporary account associated with the temporary payment authorization number by transferring funds from the temporary account to a payment credential of the recipient.

As FIGS. 2A-2C illustrate, the payment system 110 selects a payment tokenization method from one of a network tokenization method, a gateway tokenization method, and a third party tokenization method. In particular, the payment system 110 uses a plurality of different factors associated with the payment transaction to determine which payment tokenization method to select. As mentioned, the plurality of factors can include, but is not limited to, the type of payment method (e.g., payment credential), the payment authorization number, the payment gateway system associated with the payment transaction, the card network system and/or issuer associated with the payment credential of the user, and a risk level of the user/recipient.

In one or more embodiments, the payment system 110 uses a decision tree based on a plurality of factors associated with a payment transaction. Specifically, the payment system 110 can establish a hierarchy associated with the factors to determine which payment tokenization method to select. Thus, the payment system 110 can assign a priority to one or more of the available payment tokenization methods and select a highest priority payment tokenization method first before attempting to use the next highest priority payment tokenization method. Additionally, the payment system 110 can assign weights to the various factors such that certain factors weigh more or less heavily in the decision to determine which payment tokenization method to use.

In one or more embodiments, the payment system 110 also obtains one or more backup payment tokens in case the selected payment tokenization method fails. For example, the payment system 110 can select a first payment tokenization method and obtain the corresponding payment token. The payment system 110 can also select a second payment tokenization method, based on the plurality of identified factors, and obtain the corresponding payment token as a backup payment token. Thus, if the payment transaction fails with the first payment token, the payment system 110 can use the backup payment token to process the payment transaction. Additionally, the backup payment tokens can correspond to a backup payment authorization number for the user.

Additionally, when selecting a payment tokenization method, the payment system 110 can determine one or more compliance requirements associated with the different payment tokenization methods. For instance, the payment system 110 can obtain payment tokens for processing the payment transactions according to PCI standards. To illustrate, if a certain payment tokenization method requires a certain encryption or other security measures for the corresponding payment token, the payment system 110 can customize the payment transaction to use the required security measures for obtaining the payment token.

In addition to dynamically selecting the payment tokenization method for each payment transaction, the payment system 110 can also dynamically select the token exchange method for each payment transaction. As mentioned, FIGS. 3A-3C illustrate process diagrams for processing payment transactions via a plurality of token exchange methods. FIG. 3A illustrates a process diagram of dynamically selecting a client-side exchange method. Specifically, the client-side exchange method includes exchanging a payment token with a user device during a payment transaction.

In one or more embodiments, a process for exchanging a payment token with a recipient during a payment transaction begins with the payment system 110 identifying a plurality of factors for token exchange 300. In particular, after obtaining a payment token using one of the above-mentioned payment tokenization methods, the payment system 110 determines to which device/system the payment system 110 provides the payment token for initiating and completing the payment transaction. For example, the payment system 110 determines which token exchange method is best (e.g., fastest and/or most efficient) for the payment transaction according to the plurality of identified factors.

According to one or more embodiments, the factors vary for different payment transaction types, and thus can cause the payment system 110 to select different token exchange methods for the different payment transaction types. Specifically, the plurality of factors can include details about the user, the recipient, and the payment transaction. For instance, the plurality of factors can include, but are not limited to, an identity of the user, an identity of the recipient, a payment credential of the user, a card network system associated with a payment authorization number of the user, and a risk level associated with the payment transaction. Additionally, the payment system 110 can identify a preference associated with the user and/or the recipient that indicates that the token exchange method should be a client-side exchange method, such as method of initiating the payment transaction (e.g., via a JavaScript or other API call from the first client device 104a from within a merchant interface). The payment system 110 can also identify a capability of a user client device and/or recipient device/system to perform client-side token exchanges.

In one or more embodiments, the payment system 110 determines whether a recipient (e.g., the merchant system 106) of a payment transaction is integrated with the payment system 110. In particular, the merchant system 106 can be integrated with the payment system 110 if the merchant system 106 registers with the payment system (e.g., establishes an account with the payment system 110 and provides identification information and/or other information to the payment system 110). Typically, recipients such as merchants register with the payment system 110 to allow users to purchase products from the merchants within an interface provided by the payment system 110.

After identifying the plurality of factors associated with the payment transaction, the payment system 110 selects a token exchange method 302. For example, if the merchant system 106 is not integrated with the payment system 110, but is capable of processing payment transactions with a payment network 114, the payment system 110 can select the client-side exchange method. Alternatively, if the merchant system 106 is integrated with the payment system 110 or based on other factors, the payment system 110, can select another token exchange method, as described in more detail with respect to FIGS. 3B-3C.

Selecting the client-side exchange method can cause the payment system 110 to encrypt the payment token 304. For example, the payment system 110 can encrypt the payment token using an encryption key that allows the first client device 104a to decrypt and verify the information. To illustrate, the payment system 110 can identify user information associated with the payment transaction and package the user information with the encrypted payment token. The user information can include payment information such as billing information (e.g., name, address, phone number) for the user to verify in connection with the payment authorization number. The payment system 110 can then send the encrypted token 306 and other information to the first client device 104a.

When the first client device 104a receives the encrypted token and information, the first client device 104a decrypts the encrypted token 308 using the corresponding decryption key. Additionally, the first client device 104a can provide the decrypted information on a display for the user to verify the payment information 310. After the user verifies the payment information, the first client device sends the payment token 312 and other payment information to the merchant system 106. Additionally, the first client device 104a can re-encrypt the payment token and payment information to provide to the merchant system 106 according to PCI standards.

The merchant system 106 receives the payment token from the first client device 104a and the corresponding payment information for the payment transaction. The merchant system 106 then initiates the payment transaction 314 using the received payment token. To initiate the payment transaction, the merchant system 106 identifies the payment token from a data package from the first client device 104a. In one or more embodiments, the first client device 104a encrypts the payment token such that the merchant system 106 interprets the encrypted payment token as a valid payment authorization number. The merchant system 106 can identify the payment amount, purchase information, and user information for processing the payment transaction.

The merchant system 106 sends the payment token 316 and payment information to the payment network 114. The payment network 114 can include a payment gateway system that receives the payment token and payment information from the merchant system 106 and sends the payment token and payment information to a card network system to complete the payment transaction. In other embodiments, the payment gateway system can use the payment token to obtain a payment authorization number for submitting to the card network system.

In either case, the payment network 114 determines the payment authorization number from the payment token 318, as well as additional payment information (e.g., a cryptogram) to determine whether the payment transaction is valid. For example, the payment network 114 can map the payment token to the payment authorization number in a database. The payment network 114 can search for the payment token in the database to find the payment authorization number in an entry associated with the payment token. Alternatively, the payment token may be an encrypted version (e.g., hashed version) of the payment authorization number, and the payment network 114 can decrypt the payment token to obtain the payment authorization number.

After identifying the payment authorization number, the payment network 114 can process the payment transaction 320. Specifically, processing the payment transaction involves using the payment authorization number to authorize a transfer of funds from a payment account associated with the payment authorization number to a payment account associated with the merchant. For example, the payment network 114 can transfer funds from the payment account of the user to the payment account of the merchant by communicating with a bank system associated with the merchant.

Alternatively, the card network system 118 can send the payment token to the issuer 120. The issuer 120 then determines the payment authorization number based on the payment token. For example, the issuer 120 can map the payment token to the payment authorization number in a database. The issuer 120 can search for the network payment token in the database to find the payment authorization number in an entry associated with the network payment token. The issuer 120 can authorize a transfer of funds from a payment account associated with the payment authorization number to a payment account of the merchant. For example, the issuer 120 can transfer funds from the payment account of the consumer to the payment account of the merchant by communicating with a bank system (acquirer) associated with the merchant.

FIG. 3B illustrates a process diagram of dynamically selecting a server-side exchange method. In particular, the server-side exchange method includes exchanging a payment token with a server device of a recipient (e.g., the merchant system 106) during a payment transaction. Thus, the server-side exchange method involves direct communications between the merchant system 106 and the payment system 110. As shown, the server-side exchange method includes at least some operations or steps that are different from the client-side exchange method and/or the direct exchange method. The server-side exchange method can also include at least some operations or steps that are the same as the client-side exchange method and/or the direct exchange method. Additionally, process steps in FIG. 3B that are similar to process steps in FIG. 3A or FIG. 3C can involve the same, fewer, or additional operations to the corresponding process steps in FIG. 3A or FIG. 3C.

As described previously, a process for exchanging a payment token with a recipient during a payment transaction begins with the payment system 110 identifying a plurality of factors for token exchange 322. In particular, after obtaining a payment token, the payment system 110 determines how to exchange the payment token for initiating and completing the payment transaction. For example, the payment system 110 determines the best token exchange method for the payment transaction according to the plurality of identified factors.

In one or more embodiments, the payment system 110 determines whether the merchant system 106 of the payment transaction is integrated with the payment system 110. If the merchant system 106 is integrated with the payment system 110, the payment system can determine that the merchant system 106 is able to receive direct communications from the payment system 110. Thus, the merchant system 106 is able to receive payment tokens from the payment system 110 in connection with payment transactions. Additionally, the payment system 110 can identify additional factors, such as a preference associated with the merchant system 106 and/or the user of the first client device 104a. The specific payment credential, card network system, and/or the issuer of the payment authorization number can also influence whether a given exchange method is best for a payment transaction, such as if a specific exchange method is required by one or more of the entities involved.

After identifying the factors associated with the payment transaction, the payment system 110 selects a token exchange method 324. For example, the payment system 110 can select the server-side exchange method for processing the payment transaction. In particular, the payment system 110 can determine that, at least in part because the merchant system 106 is integrated with the payment system 110, the server-side exchange method is the best exchange method for the payment transaction.

In response to selecting the server-side exchange method, the payment system 110 generates a payment initiation request 326. Specifically, the payment initiation request includes payment information associated with the payment transaction, including a user identifier, a recipient identifier, payment amount, transaction identifier, etc. The payment system 110 then sends the payment initiation request with the payment token 328 to the merchant system 106. Based on the payment initiation request, the merchant system 106 can verify the payment information and initiate the payment transaction 330. Additionally, the merchant system 106 sends the payment information 332 to the payment network 114 to process the payment transaction.

To process the payment transaction, the payment network 114 receives the payment token and other payment information from the merchant system 106 (e.g., at a payment gateway system associated with the merchant system 106). The payment network 114 then determines the payment authorization number from the payment token 334. The payment network 114 also identifies additional payment information to determine whether the payment transaction is valid. The payment network 114 then processes the payment transaction 336 using the payment authorization number to authorize a transfer of funds from a payment account associated with the payment authorization number to a payment account associated with the merchant.

FIG. 3C illustrates a process diagram of dynamically selecting a direct exchange method. In particular, the direct exchange method includes exchanging a payment token directly with the payment network 114. The direct exchange method involves direct communications between the payment system 110 and the payment network, for example, on behalf of a merchant system 106. As illustrated, the direct exchange method includes at least some operations or steps that are different from the client-side exchange method and/or the server-side exchange method. The direct exchange method can also include at least some operations or steps that are the same as the client-side exchange method and/or the server-side exchange method. Additionally, process steps in FIG. 3C that are similar to process steps in FIG. 3A or FIG. 3B can involve the same, fewer, or additional operations to the corresponding process steps in FIG. 3A or FIG. 3B.

As described previously, a process for exchanging a payment token with a recipient during a payment transaction begins with the payment system 110 identifying a plurality of factors for token exchange 338. For example, the payment system 110 determines that the payment system 110 has information that identifies the payment gateway in a payment network 114 associated with the payment transaction. Specifically, the payment system 110 can identify a payment gateway system that the merchant system 106 uses to process payment transactions.

In one or more embodiments, the payment system 110 has access to a payment gateway identifier that indicates the payment gateway system or payment network used to process the payment transactions. To illustrate, the payment gateway identifier can be an identifier that the recipient (e.g., a merchant system) provides to the payment system 110 for processing payment transactions involving the merchant. Additionally, the payment system 110 can receive permission from the recipient to process the payment transaction directly with the payment network 114 on behalf of the recipient. For instance, when the payment system 110 receives a payment request involving the recipient, the payment system 110 can use information from the recipient to communicate directly with the payment network 114.

In one or more embodiments, the payment system 110 is the recipient. For example, the payment system 110 can provide products for users to purchase within a commerce application 122a. The users can select one or more products and send a payment request to purchase the one or more products from the payment system 110. Because the payment system 110 offers the products, the payment system 110 can communicate directly with the payment network 114 (e.g., a payment gateway system in the payment network 114) for processing the payment transaction.

After identifying the plurality of factors associated with the payment transaction, the payment system 110 selects the token exchange method 340. In particular, the payment system 110 selects the direct exchange method for processing the payment transaction. For example, the payment system 110 can select the direct exchange method because the payment system 110 can communicate directly with the payment network 114 for processing the payment transaction.

In response to selecting the direct exchange method, the payment system 110 initiates a payment transaction 342 between the user and the recipient. For instance, the payment system 110 can identify the payment token associated with the payment transaction and then generate a payment initiation message with the payment token and other payment information. The payment system 110 can then send the payment information 344 to the payment network 114 to begin processing the payment transaction.

In response to receiving the payment information, including the payment token, the payment network 114 can then determines the payment authorization number from the payment token 346, as well as additional payment information for determining the validity of the payment token and for processing the payment transaction. After identifying the payment authorization number based on the payment token, the payment network 114 can process the payment transaction 348. Specifically, processing the payment transaction involves using the payment authorization number to authorize a transfer of funds from a payment account associated with the payment authorization number to a payment account associated with the merchant.

As described above, the payment transaction process involves dynamically selecting a token exchange method from a client-side exchange method, a server-side exchange method, and a direct exchange method. In particular, the payment system 110 uses a plurality of different factors associated with the payment transaction to determine which token exchange method to select. As mentioned, the plurality of factors can include, but is not limited to, an identity of the first user, an identity of the second user, a payment credential of the first user, a card network system associated with a payment authorization number of the first user, or a risk level associated with the payment transaction.

As with payment tokenization, the payment system 110 can use a decision tree based on a plurality of factors associated with a payment transaction. In particular, the payment system 110 can establish a hierarchy associated with the factors to determine which token exchange method to select. As such, the payment system 110 can assign a priority to one or more of the available token exchange methods and select a highest priority token exchange method first before analyzing the next highest priority token exchange method. Additionally, the payment system 110 can assign weights to the various factors such that certain factors weigh more or less heavily in the decision to determine which token exchange method to use.

In one or more embodiments, the payment system 110 also selects one or more backup token exchange methods in case the selected token exchange method fails. For example, the payment system 110 can select a first token exchange method for a payment transaction based on the factors. The payment system 110 can also select a second token exchange method, based on the plurality of identified factors, as a backup token exchange method. Thus, if the payment transaction fails with the first token exchange method, the payment system 110 can use the backup token exchange method to process the payment transaction.

Additionally, when selecting a token exchange method, the payment system 110 can determine one or more compliance requirements associated with the different token exchange methods. For instance, the payment system 110 can pass payment tokens and payment information for processing payment transactions according to PCI standards. To illustrate, if a certain token exchange method requires a certain encryption or other security measures, the payment system 110 can customize the payment transaction to use the required security measures when sending the payment token and payment information.

In one or more embodiments, the plurality of factors for determining the token exchange method are different than the plurality of factors for determining the payment tokenization method. For instance, the payment system 110 can determine a first set of factors for tokenization and a second set of factors for token exchange, though the first set and the second set may at least partially overlap. Additionally, the process of dynamically selecting the token exchange method can be independent from the payment tokenization method. Alternatively, the process of dynamically selecting the token exchange method can be at least partially based on the payment tokenization method.

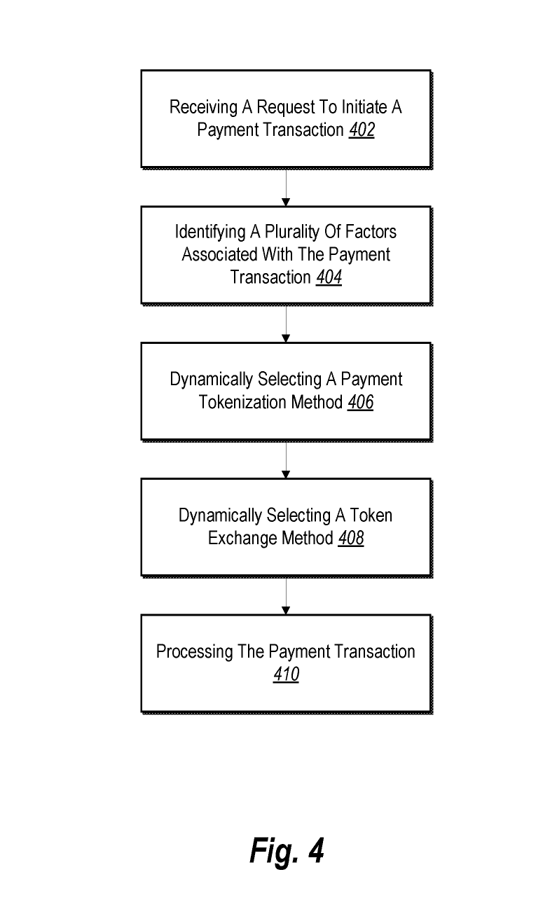

FIGS. 1-3C, the corresponding text, and the examples, provide a number of different systems and devices for processing electronic payment transactions using a payment system. In addition to the foregoing, embodiments can be described in terms of flowcharts comprising acts and steps in a method for accomplishing a particular result. For example, FIG. 4 illustrates a flowchart of an exemplary method in accordance with one or more embodiments.

FIG. 4 illustrates a flowchart of a method 400 of processing payment transactions with dynamic payment token generation and exchange. The method 400 includes an act 402 of receiving a request to initiate a payment transaction. For example, act 402 involves receiving, from a client device 104a associated with a first user 102a, a request to initiate a payment transaction. Act 402 can involve receiving a request to initiate a payment transaction between the first user 102a and a merchant. Act 402 can alternatively involve receiving a request to initiate a peer-to-peer payment transaction between the first user 102a and a second user.

The method 400 also includes an act 404 of identifying a plurality of factors associated with the payment transaction. For example, act 404 can involve determining a plurality of relationships between two or more of a sender of the payment transaction, a recipient of the payment transaction, a payment gateway system 116, a card network system 118, and a payment system 110.

Act 404 can involve identifying a set of factors for determining the payment tokenization method, the set of factors comprising at least one of a payment credential of the first user 102a, a payment credential of a recipient of the payment transaction, a payment gateway system 116 associated with the recipient of the payment transaction, a card network system 118 associated with a payment authorization number of the first user 102a, or a risk level associated with the payment transaction.

Act 404 can also involve identifying a set of factors for determining the token exchange method, the set of factors comprising at least one of an identity of the first user 102a, an identity of a recipient of the payment transaction, a payment credential of the first user 102a, a card network system 118 associated with a payment authorization number of the first user 102a, or a risk level associated with the payment transaction.

Act 404 can further involve generating a decision tree based on the plurality of factors associated with the payment transaction. For example, act 404 can involve assigning weights to the plurality of factors. Furthermore, act 404 can involve assigning priorities to the payment tokenization methods and the token exchange methods.

The method 400 further includes an act 406 of dynamically selecting a payment tokenization method. For example, act 406 involves dynamically selecting, based on the plurality of factors, a payment tokenization method from one of a network tokenization method, a gateway tokenization method, or a third party tokenization method. For example, act 406 can involve dynamically selecting, based on a determined plurality of relationships, the payment tokenization method.

Act 406 can involve determining that a payment authorization number associated with the first user 102a is tokenizable by a card network system 118 associated with the payment authorization number, selecting the network tokenization method for tokenizing the payment authorization number based on the payment authorization number being tokenizable by the card network system 118, and obtaining, from the card network system 118, a network payment token using the network tokenization method.

Act 406 can involve determining that the one or more servers are integrated with a payment gateway system 116 that processes payment transactions for a recipient of the payment transaction, selecting the gateway tokenization method for tokenizing the payment authorization number based on the one or more servers being integrated with the payment gateway system 116, and obtaining, from the payment gateway system, a gateway payment token using the gateway tokenization method.

Act 406 can involve determining that the payment authorization number associated with the first user 102a is not tokenizable using the network tokenization method or the gateway tokenization method, selecting the third party tokenization method for tokenizing the payment authorization number based on the payment authorization number not being tokenizable using the network tokenization method or the gateway tokenization method, and obtaining, from a third party tokenizer 112, a third party token using the third party tokenization method.

As part of act 406, or as an additional act, the method 400 can include determining that the selected payment tokenization method fails to generate a payment token for processing the payment transaction, and selecting a new payment tokenization method from one of the network tokenization method, the gateway tokenization method, or the third party tokenization method for processing the payment transaction.

Additionally, the method 400 includes an act 408 of dynamically selecting a token exchange method. For example, act 408 involves dynamically selecting, based on the plurality of factors, a token exchange method from one of a client-side exchange method, a server-side exchange method, or a direct exchange method. For example, act 408 can involve dynamically selecting, based on the determined plurality of relationships, the token exchange method.

Act 408 can involve determining that a recipient of the payment transaction is associated with a merchant system 106 that is integrated with the one or more servers, selecting the server-side exchange method to exchange a payment token associated with the payment transaction with the merchant system 106, and providing the payment token associated with the payment transaction to the merchant system using the server-side exchange method.

Act 408 can involve determining that a recipient of the payment transaction is not associated with a merchant system 106 that is integrated with the one or more servers, selecting the client-side exchange method to exchange a payment token associated with the payment transaction with the client device 104a associated with the first user 102a for the client device 104a to provide to the merchant system 106, and providing the payment token associated with the payment transaction to the client device 104a using the client-side exchange method.

Act 408 can involve determining that the one or more servers are able to process the payment transaction directly with a payment network 114 associated with a merchant system 106, selecting the direct exchange method to exchange a payment token associated with the payment transaction with the payment network 114, and providing the payment token associated with the payment transaction to the payment network 114 using the direct exchange method.

As part of act 408, or as an additional act, the method 400 can include determining that the selected token exchange method fails to exchange a payment token for processing the payment transaction, and selecting a new token exchange method from one of the client-side exchange method, the server-side exchange method, or the direct exchange method for processing the payment transaction.

Additionally, act 408 can involve selecting the token exchange method independently of the selected payment tokenization method. Alternatively, act 408 can involve selecting the token exchange method at least partially based on the selected payment tokenization method.

The method 400 also includes an act 410 of processing the payment transaction. For example, act 410 involves processing the payment transaction according to the selected payment tokenization method and the selected token exchange method. For example, act 410 can involve processing the payment transaction with a payment token that was tokenized using the selected payment tokenized method and exchanged using the selected token exchange method.

The method 400 can also include determining, based on the plurality of factors, that a plurality of payment tokenization methods are available for the payment transaction, determining, from the plurality of available payment tokenization methods, a payment tokenization method with a fastest estimated processing time, selecting the payment tokenization method with the fastest estimated processing time for processing the payment transaction, and processing the payment transaction using the selected payment tokenization method.

The method 400 can further include determining, based on the plurality of factors, a backup payment tokenization method from one of a network tokenization method, a gateway tokenization method, or a third party tokenization method and a backup token exchange method from one of a client-side exchange method, a server-side exchange method, or a direct exchange method. The method 400 can further include detecting that the selected payment tokenization method or the selected token exchange method fails, selecting, based on the selected payment tokenization method or the selected token exchange method failing, the backup payment tokenization method or the backup token exchange method for processing the payment transaction, and processing the payment transaction using the selected backup payment tokenization method or the selected backup token exchange method.

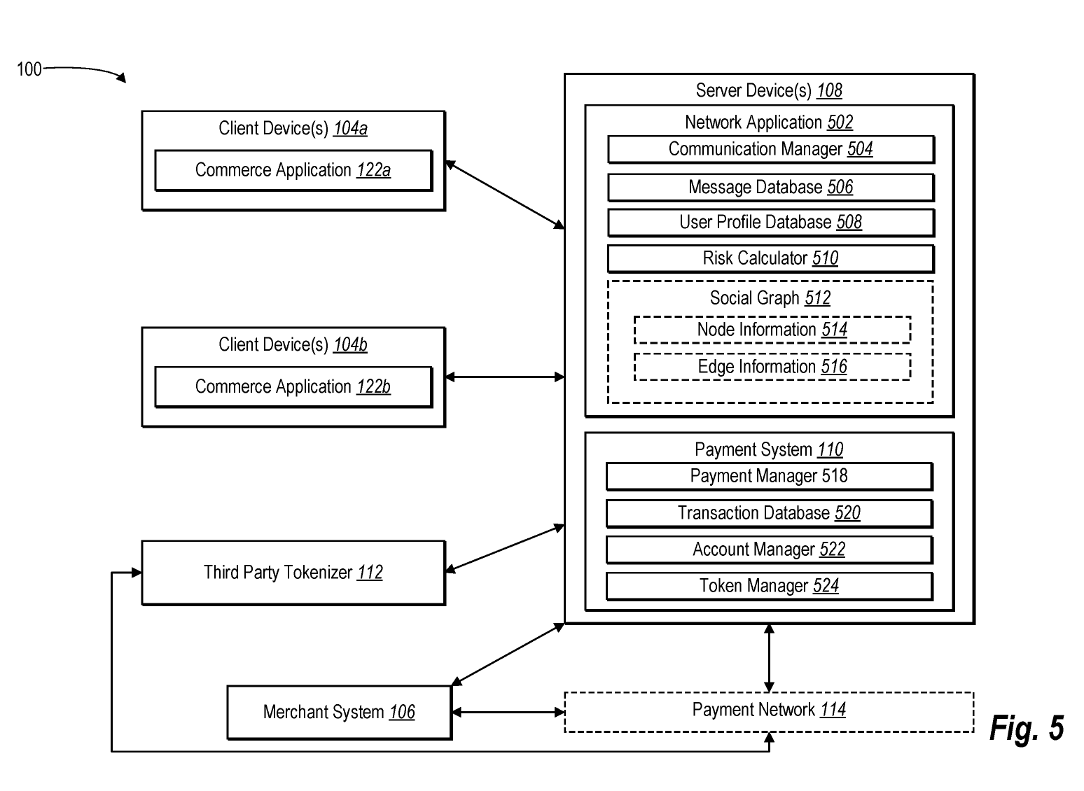

FIG. 5 illustrates a schematic diagram illustrating additional details of the environment of FIG. 1 that includes the payment system 110. As shown, the environment 100 can include a first client device 104a, a second client device 104b, a merchant system 106, server device(s) 108 that includes the payment system 110, a third party tokenizer 112, and a payment network 114. Additionally, the payment network 114 includes the payment gateway system 116, the card network system 118 associated with the payment authorization number, and the issuer 120 as described above in relation to FIG. 1. In general, the payment system 110 allows a user associated with the first client device 104a to send a payment to a merchant associated with the merchant system 106 or to another user associated with the second client device 104b.

FIG. 5 illustrates that the first client device 104a and the second client device include commerce applications 122a, 122b (an e-commerce application or a web browser), and the server device(s) 108 include a network application 502 and the payment system 110 with various components. The components of the network application 502, the components of the payment system 110, and the commerce applications 122a, 122b can work together to allow a user to send payments to a recipient, as described in greater detail below.

FIG. 5 illustrates that the network application 502 includes a communication manager 504, a message database 506, a user profile database 508, and a risk calculator 510. As described below, the network application 502 can also optionally include a social graph 512, which includes node information 514 and edge information 516. FIG. 5 further illustrates that the payment system 110 includes a payment manager 518, a transaction database 520, an account manager 522, and a token manager 524. Each of the components of the client devices 104a, 104b, the merchant system 106, and the server device(s) 108 can communicate with each other or with components using any suitable communication technologies. It will be recognized that although the components of the network application 502 and the payment system 110 are shown to be separate in FIG. 5, any of the components may be combined into fewer components, such as into a single facility or module, or divided into more components as may serve a particular embodiment. While FIG. 5 describes certain components as part of the network application 502 and other components as part of the payment system 110, the present disclosure is not so limited. In alternative embodiments, one or more of the components shown as part of the network application 502 can be part of the payment system 110, or vice versa.

The components can include software, hardware, or both. For example, the components can include computer instructions stored on a non-transitory computer-readable storage medium and executable by at least one processor of the server device(s) 108. When executed by the at least one processor, the computer-executable instructions can cause the server device(s) 108 to perform the methods and processes described herein. Alternatively, the components can include hardware, such as a special purpose processing device to perform a certain function or group of functions. Additionally or alternatively, the components can include a combination of computer-executable instructions and hardware.

In one or more embodiments, the commerce application 122a, 122b is a native application installed on a client device. For example, the commerce application 122a, 122b may be a mobile application that installs and runs on a mobile device, such as a smart phone or a tablet. In another example, the commerce application 122a, 122b can be a desktop application, widget, or other form of a native computer program. Alternatively, the commerce application 122a, 122b may be a remote application that the client device accesses. For example, the commerce application 122a, 122b may be a web application that is executed within a web browser of the client device.

The commerce application 122a on the first client device 104a facilitates payment transactions with other users (e.g., peer users or merchants). For example, the commerce application 122a can facilitate the sending of a payment associated with a payment transaction. In particular, the commerce application 122a can communicate with the network application 502, the payment system 110, and the merchant system 106 to send and receive information associated with payment transactions. For example, the commerce application 122a can send and receive payment tokens or other tokens associated with payment transactions.

As briefly mentioned above, the payment system 110 can further include a network application 502 that is implemented in whole or in part on the server device(s) 108. In one or more embodiments of the present disclosure, the network application 502 comprises a social-networking system (such as but not limited to FACEBOOK™), but in other embodiments the network application 502 may comprise another type of application, including but not limited to an e-mail application, search engine application, banking application, or any number of other application types that utilizes user accounts.

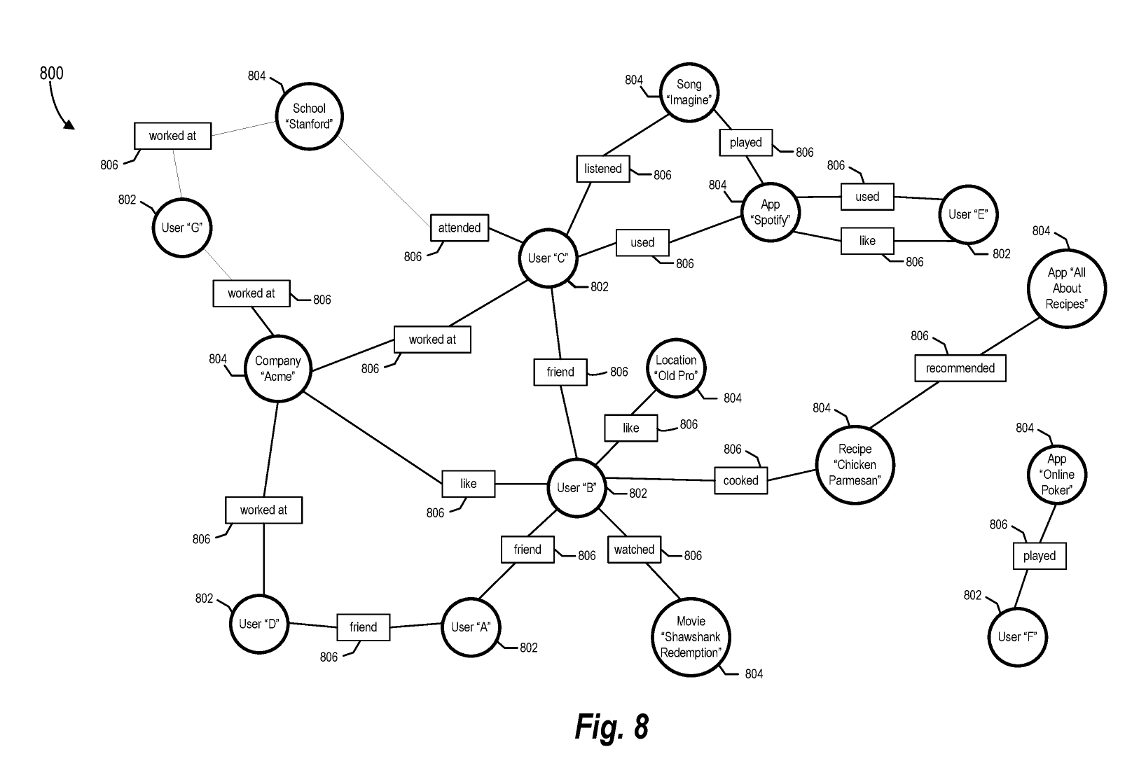

In one or more embodiments where the network application 502 comprises a social-networking system, the network application may include a social graph 512 for representing and analyzing a plurality of users and concepts. Node storage of the social graph 512 can store node information 514 comprising nodes for users, nodes for concepts, nodes for transactions, and nodes for items. Edge storage of the social graph can store edge information 516 comprising relationships between nodes and/or actions occurring within the social-networking system. Further detail regarding social-networking systems, social graphs, edges, and nodes is presented below with respect to FIG. 8.

The communication manager 504 can process messages received from the commerce application 122a. For example, the communication manager 504 can receive and manage payment requests from users. The communication manager 504 may receive a payment request from the commerce application 122a, detect payment information associated with the payment request, and pass the information to the payment system 110.

The network application may also include a message database 506. The message database 506 can maintain message data associated with payment transactions related to identities of users or merchants engaging in payment transactions. Specifically, the message database 506 can maintain a history of a user's engagements with one or more merchants for use in identifying a user's interests or preferences. For example, the message database 506 can maintain information representative of the user's interests based on the types of merchants from which the user purchases products, which the social graph 512 can access to influence the node information 514 or edge information 516 for the user. The message database 506 can also redact sensitive information (e.g., payment information) that the payment system 110 maintains separately from the network application 502. Additionally, or alternatively, such information can be maintained in the transaction database 520, as described below.

As mentioned previously, the server device(s) can include a payment system 110 having a payment manager 518. The payment manager 518 of FIG. 5 can integrate the sending and receiving of payment requests and initiate payment transactions, and may employ one or more application programming interfaces (APIs). For example, upon the communication manager 504 receiving a payment request, the communication manager 504 can send any payment details to the payment manager 518. The payment manager 518 can then use the payment details retrieved from the payment request to initiate a payment transaction using the payment network 114.

According to one or more embodiments, the server device(s) 108 can maintain the payment system 110 separate from the network application 502. For example, the server device(s) 108 can implement payment processes associated with the payment system 110 separately from at least some of the functionality of the network application (e.g., using a messaging database for recovery). To illustrate, the server device(s) 108 can implement the functionality of the payment system 110 on a first group of one or more servers and the functionality of the network application 502 on a second group of one or more servers. Implementing functionality of the payment system 110 and the network application 502 on separate servers can allow the payment system to ensure that at least some of the financial information associated with the users is maintained apart from the network application 502 to comply with Payment Card Industry (PCI) standards. Alternative configurations of servers and/or software than those described herein may also allow the server device(s) 108 to comply with PCI standards.

The payment manager 518 can coordinate a transaction corresponding to a payment defined in a payment request. As generally explained above, the payment manager 518 can coordinate a transaction via the payment network 114 that corresponds to a payment request, monitor the status of the transaction, and provide status information regarding the transaction. More specifically, the payment network 114 can authorize a transaction, fund a transaction, and/or settle an individual transaction or batch of transactions. In one or more embodiments, the payment manager 518 can use one or more application programming interfaces (API) to communicate relevant information with the payment network 114.

In additional or alternative embodiments, the commerce application 122a on the first client device 104a can cause the first client device 122a to send a payment request to the network application 502 and the payment system 110 in parallel. In particular, when the client application 502 receives a selection by the user to pay an amount to the recipient, the client application 502 can cause the first client device 104a to send a payment request to the network application 502 and to the payment system 110. Thus, the network application 502 can process the payment request while the payment system 110 is also processing the payment transaction associated with the payment request. In alternative embodiments, the first client device 104a can send messages to one or more servers associated with the network application 502, which can then forward the messages to the payment system 110, or vice versa.

To complete a transaction, the payment manager 518 can access or obtain payment credentials for the user. Specifically, the payment manager 518 identifies a payment credential (e.g., a payment authorization number) for the user in connection with a payment account of the user. The payment manager 518 can register one or more payment accounts or other payment credentials for the user with the network application 502. In additional embodiments, the payment system 110 is also capable of handling payment transactions directly with merchant systems that integrate with the payment system 110. Thus, the payment system 110 can also manage payment transactions directly with those merchant systems.

The payment manager 518 can also dynamically determine how to process payment transactions. For example, the payment manager 518 dynamically selects a payment tokenization method based on a plurality of factors associated with the payment transaction. The payment manager 518 can then obtain a payment token for a payment authorization number of the user according to the selected payment tokenization method (e.g., a network tokenization method, a gateway tokenization method, or a third party tokenizer) for use in processing the payment transaction. In one or more embodiments, the payment manager 518 obtains the payment token from the payment network 114 (e.g., the payment gateway system or the card network system) or from the third party tokenizer 112.

The payment manager 518 also dynamically selects a token exchange method based on a plurality of factors associated with the payment transaction. The payment manager 518 causes the payment system 110 to obtain the payment token by exchanging the payment token according to the selected token exchange method (e.g., a client-side exchange method, a server-side exchange method, or a direct exchange method). According to one or more embodiments, the payment manager 518 causes the payment system 110 to exchange the payment token with the first client device 104a, the merchant system 106, or the payment network 114.

Upon the user registering a deposit account or other payment credential, the user profile database 508 can maintain the payment credential or user information associated with the payment credential for the user. After the payment manager 518 receives the payment information for a payment transaction from a user, the payment manager 518 can identify the recipient. At this point, the payment manager 518 can initiate the transaction using the payment credential information associated with the user.

As mentioned, the user profile database 508 stores user profile information for users. In one or more embodiments, user profile information includes payment credentials (i.e., a payment token representing a payment authorization number, as described previously) for a credit card, a debit card, a deposit account or other bank accounts, gift card accounts, store credit accounts, etc. The user profile database 508 can also store additional information associated with the payment credentials, such as expiration dates, security codes, address information, and/or other information. User profile information can also include one or more default payment method for payment transactions for one or more merchants or co-users. The user profile information can also include identifying information for the user, such as name, address, etc. to allow the payment manager 518 to provide information to the one or more other components in connection with a payment transaction.

In one or more additional embodiments, the payment manager 518 can communicate with the risk calculator 510 to determine a risk associated with a sender, a recipient, and/or a particular payment transaction. Specifically, the risk calculator 510 can determine whether the sender/recipient is a fraudster based on information associated with the sender/recipient in order to prevent fraudulent payment transactions. For example, the risk calculator 510 can determine the likelihood of fraudulent activity based on activity or information associated with the sender/recipient in connection with the network application. Determining a risk associated with users involved in payment transactions can also be useful in determining whether to process a particular payment transaction.

For example, in one or more embodiments, the network application can determine whether a risk associated with a particular user satisfies a predetermined threshold. In particular, the network application can determine whether a user is a fraudster (e.g., a scam account or software posing as a real person) based on a “realness” score. For example, if the risk associated with the sender is below a predetermined threshold (i.e., a high risk level), the network application can determine that the user is likely a fraudster and notify the payment system 110 that the user is a fraudster. If the user has a high-risk level, the payment system 110 can stop a payment transaction between the user and the recipient.

In additional embodiments, after determining a risk associated with a user, the network application 502 can perform one or more actions in association with the risk. Specifically, the network application 502 can perform an action that allows the network application 502 to verify the identity of the user. For example, the network application 502 can identify information associated with the user that indicates the user is who the user purports to be. To illustrate, the network application 502 can access the user's purchase history or other stored information in the message database 506 or user profile database 508, which can influence the risk level or realness score of the user.

In additional or alternative embodiments, the network application 502 can automatically perform one or more actions with respect to the payment request or a payment transaction in response to determining a risk level of the user. Specifically, the network application 502 can perform an action that affects the payment request or a corresponding payment transaction between the user and the recipient without requesting additional information from the user. For example, the network application 502 can allow the payment transaction, block the payment transaction, or disable the user's account with the network application 502.

The payment manager 518 can perform various other additional steps and methods in order to effectively manage the payment process. In one or more embodiments, for example, upon receiving a payment request the payment manager 518 can generate a transaction identifier (or simply “transaction ID”) and associate the transaction identifier with the payment request and/or the payment information within the payment request. For instance, upon generating a transaction ID, the payment manager 518 can send the transaction ID and the payment information to the transaction database 520. The transaction database 520 can include a data table or similar data matrix that stores transaction information according to transaction ID.

The transaction database 520 of FIG. 5 can provide storage for each transaction (such as in the form of a graph object), attempted or completed, the transaction ID, a date, an amount of the transaction, the payment method used, and any other information gathered on the transaction. The transaction database 520 can also store transaction information, such as requests associated with a user and the terms for a particular transaction. With this information, the payment manager 518 can provide, upon request, a summary of one or more transactions to users as a history of payments requested, payments declined and payments completed.

In one or more embodiments, after a transaction ID is associated with a particular payment request, the transaction ID can be included or embedded within substantially all communications within the payment system relating to the particular payment. As such, the transaction ID allows the payment manager 518 to manage and process a large number of payments in an organized fashion. For example, the payment manager 518 can include instructions to include the transaction ID in any information sent to client devices. In return, the message handlers 512 can also include the transaction ID in any information sent from client devices to allow the payment manager 518 to efficiently and reliably identify a particular transaction to which the information corresponds.

In one or more embodiments, the transaction ID can be associated with one or more user identifiers, merchant identifiers, payment amounts, payment methods (e.g., user accounts), deposit methods (e.g., merchant accounts), transaction history, current transaction status, as well as other transaction information. In one or more embodiments, the transaction database 520 maintains the transaction information in the form of one or more graph objects that are updated with any updates or actions with respect to a transaction.

As mentioned, the payment system 110 can also include a token manager 524. The token manager 524 can manage payment tokens associated with users of the payment system. For example, after the payment manager 518 requests and obtains a payment token from a payment network 114 for a user's payment authorization number, the token manager 524 can associate the payment token with the user's user account. The token manager 524 can associate the network payment token with the user profile of the user by storing information linking the payment token to the user profile of the user, for example, at the user profile database 508.

The token manager 524 can communicate with the payment manager 518 and the user profile database 508 when the payment manager 518 receives a new payment request. Specifically, the token manager 524 identifies the network payment token for a user that sends the payment request based on payment information that identifies a user profile of the user. The token manager 524 can also identify other tokens associated with the user, such as any security/authentication tokens that allow the user to initiate payment transactions, as may serve various embodiments.

The token manager 524 can also manage the encryption of payment tokens in connection with payment transactions. In particular, exchanging a payment token can include encrypting the payment token for passing to one or more other devices or systems. For example, the token manager 524 can encrypt a payment token in a data package to send to another device or system using an encryption key. The type of encryption can be based on the selected token exchange method. For example, a client-side exchange method can involve encrypting the payment token using a different encryption method or key than a server-side exchange method or a direct exchange method. The token manager 524 can also encrypt the data package according to PCI standards in accordance with the selected token exchange method.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the payment system 110. As shown by FIG. 6, the computing device 600 can comprise a processor 602, a memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touchscreen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the payment system 110 can comprise a social-networking system. A social-networking system may enable its users (such as persons or organizations) to interact with the system and with each other. As mentioned above, the payment system 110 can comprise a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, on-line calendars and event organization, messaging, games, or advertisements) to facilitate social interaction between or among users. Also, the social-networking system may allow users to post photographs and other multimedia content items to a user's profile page (typically known as “wall posts” or “timeline posts”) or in a photo album, both of which may be accessible to other users of the social-networking system depending upon the user's configured privacy settings.

FIG. 7 illustrates an example network environment 700 of a social-networking system. Network environment 700 includes a client system 706, a social-networking system 702, and a third-party system 708 connected to each other by a network 704. Although FIG. 7 illustrates a particular arrangement of client system 706, social-networking system 702, third-party system 708, and network 704, this disclosure contemplates any suitable arrangement of client system 706, social-networking system 702, third-party system 708, and network 704. As an example and not by way of limitation, two or more of client system 706, social-networking system 702, and third-party system 708 may be connected to each other directly, bypassing network 704. As another example, two or more of client system 706, social-networking system 702, and third-party system 708 may be physically or logically co-located with each other in whole or in part. Moreover, although FIG. 7 illustrates a particular number of client systems 706, social-networking systems 702, third-party systems 708, and networks 704, this disclosure contemplates any suitable number of client systems 706, social-networking systems 702, third-party systems 708, and networks 704. As an example and not by way of limitation, network environment 700 may include multiple client system 706, social-networking systems 702, third-party systems 708, and networks 704.

This disclosure contemplates any suitable network 704. As an example and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client system 706, social-networking system 702, and third-party system 708 to communication network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client system 706 may be an electronic device including hardware, software, or embedded logic components or a combination of two or more such components and capable of carrying out the appropriate functionalities implemented or supported by client system 706. As an example and not by way of limitation, a client system 706 may include any of the computing devices discussed above in relation to FIG. 7. A client system 706 may enable a network user at client system 706 to access network 704. A client system 706 may enable its user to communicate with other users at other client systems 706.

In particular embodiments, client system 706 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 706 may enter a Uniform Resource Locator (URL) or other address directing the web browser to a particular server (such as server, or a server associated with a third-party system 708), and the web browser may generate a Hyper Text Transfer Protocol (HTTP) request and communicate the HTTP request to server. The server may accept the HTTP request and communicate to client system 706 one or more Hyper Text Markup Language (HTML) files responsive to the HTTP request. Client system 706 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 702 may be a network-addressable computing system that can host an online social network. Social-networking system 702 may generate, store, receive, and send social-networking data, such as, for example, user-profile data, concept-profile data, social-graph information, or other suitable data related to the online social network. Social-networking system 702 may be accessed by the other components of network environment 700 either directly or via network 704. In particular embodiments, social-networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social-networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 706, a social-networking system 702, or a third-party system 708 to manage, retrieve, modify, add, or delete, the information stored in data store.

In particular embodiments, social-networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social-networking system 702 may provide users of the online social network the ability to communicate and interact with other users. In particular embodiments, users may join the online social network via social-networking system 702 and then add connections (e.g., relationships) to a number of other users of social-networking system 702 whom they want to be connected to. Herein, the term “friend” may refer to any other user of social-networking system 702 with whom a user has formed a connection, association, or relationship via social-networking system 702.

In particular embodiments, social-networking system 702 may provide users with the ability to take actions on various types of items or objects, supported by social-networking system 702. As an example and not by way of limitation, the items and objects may include groups or social networks to which users of social-networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 702 or by an external system of third-party system 708, which is separate from social-networking system 702 and coupled to social-networking system 702 via a network 704.

In particular embodiments, social-networking system 702 may be capable of linking a variety of entities. As an example and not by way of limitation, social-networking system 702 may enable users to interact with each other as well as receive content from third-party systems 708 or other entities, or to allow users to interact with these entities through an application programming interfaces (API) or other communication channels.

In particular embodiments, a third-party system 708 may include one or more types of servers, one or more data stores, one or more interfaces, including but not limited to APIs, one or more web services, one or more content sources, one or more networks, or any other suitable components, e.g., that servers may communicate with. A third-party system 708 may be operated by a different entity from an entity operating social-networking system 702. In particular embodiments, however, social-networking system 702 and third-party systems 708 may operate in conjunction with each other to provide social-networking services to users of social-networking system 702 or third-party systems 708. In this sense, social-networking system 702 may provide a platform, or backbone, which other systems, such as third-party systems 708, may use to provide social-networking services and functionality to users across the Internet.

In particular embodiments, a third-party system 708 may include a third-party content object provider. A third-party content object provider may include one or more sources of content objects, which may be communicated to a client system 706. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 702 also includes user-generated content objects, which may enhance a user's interactions with social-networking system 702. User-generated content may include anything a user can add, upload, send, or “post” to social-networking system 702. As an example and not by way of limitation, a user communicates posts to social-networking system 702 from a client system 706. Posts may include data such as status updates or other textual data, location information, photos, videos, links, music or other similar data or media. Content may also be added to social-networking system 702 by a third-party through a “communication channel,” such as a newsfeed or stream.

In particular embodiments, social-networking system 702 may include a variety of servers, sub-systems, programs, modules, logs, and data stores. In particular embodiments, social-networking system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 702 may also include suitable components such as network interfaces, security mechanisms, load balancers, failover servers, management-and-network-operations consoles, other suitable components, or any suitable combination thereof. In particular embodiments, social-networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 702 to one or more client systems 706 or one or more third-party system 708 via network 704. The web server may include a mail server or other messaging functionality for receiving and routing messages between social-networking system 702 and one or more client systems 706. An API-request server may allow a third-party system 708 to access information from social-networking system 702 by calling one or more APIs. An action logger may be used to receive communications from a web server about a user's actions on or off social-networking system 702. In conjunction with the action log, a third-party-content-object log may be maintained of user exposures to third-party-content objects. A notification controller may provide information regarding content objects to a client system 706. Information may be pushed to a client system 706 as notifications, or information may be pulled from client system 706 responsive to a request received from client system 706. Authorization servers may be used to enforce one or more privacy settings of the users of social-networking system 702. A privacy setting of a user determines how particular information associated with a user can be shared. The authorization server may allow users to opt in to or opt out of having their actions logged by social-networking system 702 or shared with other systems (e.g., third-party system 708), such as, for example, by setting appropriate privacy settings. Third-party-content-object stores may be used to store content objects received from third parties, such as a third-party system 708. Location stores may be used for storing location information received from client systems 706 associated with users. Advertisement-pricing modules may combine social information, the current time, location information, or other suitable information to provide relevant advertisements, in the form of notifications, to a user.

FIG. 8 illustrates example social graph 800. In particular embodiments, social-networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social-networking system 702, client system 706, or third-party system 708 may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of social-networking system 702. As an example and not by way of limitation, a user may be an individual (human user), an entity (e.g., an enterprise, business, or third-party application), or a group (e.g., of individuals or entities) that interacts or communicates with or over social-networking system 702. In particular embodiments, when a user registers for an account with social-networking system 702, social-networking system 702 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social-networking system 702. In particular embodiments, a user node 802 may be associated with information provided by a user or information gathered by various systems, including social-networking system 702. As an example and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 702 or a third-party website associated with a web-application server); an entity (such as, for example, a person, business, group, sports team, or celebrity); a resource (such as, for example, an audio file, video file, digital photo, text file, structured document, or application) which may be located within social-networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including social-networking system 702. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social-networking system 702. Profile pages may also be hosted on third-party websites associated with a third-party server 708. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 708. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 706 to send to social-networking system 702 a message indicating the user's action. In response to the message, social-networking system 702 may create an edge (e.g., an “eat” edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social-networking system 702 may send a “friend request” to the second user. If the second user confirms the “friend request,” social-networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to a edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social-networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social-networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social-networking system 702 may create an edge 806 between a user node 802 and a concept node 804 in social graph 800. As an example and not by way of limitation, a user viewing a concept-profile page (such as, for example, by using a web browser or a special-purpose application hosted by the user's client system 706) may indicate that he or she likes the concept represented by the concept node 804 by clicking or selecting a “Like” icon, which may cause the user's client system 706 to send to social-networking system 702 a message indicating the user's liking of the concept associated with the concept-profile page. In response to the message, social-networking system 702 may create an edge 806 between user node 802 associated with the user and concept node 804, as illustrated by “like” edge 806 between the user and concept node 804. In particular embodiments, social-networking system 702 may store an edge 806 in one or more data stores. In particular embodiments, an edge 806 may be automatically formed by social-networking system 702 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 702 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 702) or RSVP (e.g., through social-networking system 702) to an event associated with the advertisement. In addition or as an alternative, an advertisement may include social-networking-system context directed to the user. As an example and not by way of limitation, an advertisement may display information about a friend of the user within social-networking system 702 who has taken an action associated with the subject matter of the advertisement.

In particular embodiments, social-networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 708 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 702 may calculate a coefficient based on a user's actions. Social-networking system 702 may monitor such actions on the online social network, on a third-party system 708, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 702 may calculate a coefficient based on the user's actions with particular types of content. The content may be associated with the online social network, a third-party system 708, or another suitable system. The content may include users, profile pages, posts, news stories, headlines, instant messages, chat room conversations, emails, advertisements, pictures, video, music, other suitable objects, or any combination thereof. Social-networking system 702 may analyze a user's actions to determine whether one or more of the actions indicate an affinity for subject matter, content, other users, and so forth. As an example and not by way of limitation, if a user may make frequently posts content related to “coffee” or variants thereof, social-networking system 702 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 702 may calculate a coefficient based on the type of relationship between particular objects. Referencing the social graph 800, social-networking system 702 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 702 may determine that the user has a higher coefficient with respect to the first photo than the second photo because having a tagged-in-type relationship with content may be assigned a higher weight and/or rating than having a like-type relationship with content. In particular embodiments, social-networking system 702 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 702 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, social-networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 706 of the user). A first user may be more interested in other users or concepts that are closer to the first user. As an example and not by way of limitation, if a user is one mile from an airport and two miles from a gas station, social-networking system 702 may determine that the user has a higher coefficient for the airport than the gas station based on the proximity of the airport to the user.

In particular embodiments, social-networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 702 may provide information that is relevant to user's interests and current circumstances, increasing the likelihood that they will find such information of interest. In particular embodiments, social-networking system 702 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 702 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 708 (e.g., via an API or other communication channel), or from another suitable system. In response to the request, social-networking system 702 may calculate the coefficient (or access the coefficient information if it has previously been calculated and stored). In particular embodiments, social-networking system 702 may measure an affinity with respect to a particular process. Different processes (both internal and external to the online social network) may request a coefficient for a particular object or set of objects. Social-networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/642,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by social-networking system 702 or shared with other systems (e.g., third-party system 708). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 708, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social-networking system 702 may send a request to the data store for the object. The request may identify the user associated with the request and may only be sent to the user (or a client system 706 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method comprising:
receiving, from a client device associated with a first user, a request to initiate a payment transaction;
identifying, by one or more servers, a plurality of factors associated with the payment transaction;
dynamically selecting, based on the plurality of factors, a payment tokenization method from one of a network tokenization method, a gateway tokenization method, or a third party tokenization method;
dynamically selecting, based on the plurality of factors, a token exchange method from one of a client-side exchange method, a server-side exchange method, or a direct exchange method; and
processing the payment transaction according to the selected payment tokenization method and the selected token exchange method.

2. The method as recited in claim 1, wherein dynamically selecting the payment tokenization method comprises:
determining that a payment authorization number associated with the first user is tokenizable by a card network system associated with the payment authorization number;
selecting the network tokenization method for tokenizing the payment authorization number based on the payment authorization number being tokenizable by the card network system; and
obtaining, from the card network system, a network payment token using the network tokenization method.

3. The method as recited in claim 1, wherein dynamically selecting the payment tokenization method comprises:
determining that the one or more servers are integrated with a payment gateway system that processes payment transactions for a recipient of the payment transaction;
selecting the gateway tokenization method for tokenizing the payment authorization number based on the one or more servers being integrated with the payment gateway system; and
obtaining, from the payment gateway system, a gateway payment token using the gateway tokenization method.

4. The method as recited in claim 1, wherein dynamically selecting the payment tokenization method comprises:
determining that the payment authorization number associated with the first user is not tokenizable using the network tokenization method or the gateway tokenization method;
selecting the third party tokenization method for tokenizing the payment authorization number based on the payment authorization number not being tokenizable using the network tokenization method or the gateway tokenization method; and
obtaining, from a third party tokenizer, a third party token using the third party tokenization method.

5. The method as recited in claim 1, wherein identifying the plurality of factors comprises identifying a first set of factors for determining the payment tokenization method, the first set of factors comprising at least one of a payment credential of the first user, a payment credential of a recipient, a payment gateway system associated with a recipient of the payment transaction, a card network system associated with a payment authorization number of the first user, or a risk level associated with the payment transaction.

6. The method as recited in claim 1, wherein dynamically selecting the token exchange method comprises:
determining that a recipient of the payment transaction is associated with a merchant system that is integrated with the one or more servers;
selecting the server-side exchange method to exchange a payment token associated with the payment transaction with the merchant system; and
providing the payment token associated with the payment transaction to the merchant system using the server-side exchange method.

7. The method as recited in claim 1, wherein dynamically selecting the token exchange method comprises:
determining that a recipient of the payment transaction is not associated with a merchant system that is integrated with the one or more servers;
selecting the client-side exchange method to exchange a payment token associated with the payment transaction with the client device associated with the first user for the client device to provide to the merchant system; and
providing the payment token associated with the payment transaction to the client device using the client-side exchange method.

8. The method as recited in claim 1, wherein dynamically selecting the token exchange method comprises:
determining that the one or more servers are able to process the payment transaction directly with a payment network associated with a merchant system;
selecting the direct exchange method to exchange a payment token associated with the payment transaction with the payment network; and
providing the payment token associated with the payment transaction to the payment network using the direct exchange method.

9. The method as recited in claim 1, wherein identifying the plurality of factors comprises identifying a second set of factors for determining the token exchange method, the second set of factors comprising at least one of an identity of the first user, an identity of the second user, a payment credential of the first user, a card network system associated with a payment authorization number of the first user, or a risk level associated with the payment transaction.

10. The method as recited in claim 1, further comprising:
determining that the selected payment tokenization method fails to generate a payment token for processing the payment transaction; and
selecting a new payment tokenization method from one of the network tokenization method, the gateway tokenization method, or the third party tokenization method for processing the payment transaction.

11. The method as recited in claim 1, further comprising:
determining that the selected token exchange method fails to exchange a payment token for processing the payment transaction; and
selecting a new token exchange method from one of the client-side exchange method, the server-side exchange method, or the direct exchange method for processing the payment transaction.

12. The method as recited in claim 1, further comprising customizing security measures for the payment transaction to comply with Payment Card Industry standards based on the selected payment tokenization method and the selected token exchange method.

13. A system comprising:
at least one processor; and
a non-transitory computer readable storage medium comprising instructions that, when executed by the at least one processor, cause the system to:
receive, from a client device associated with a first user, a request to initiate a payment transaction;
identify a plurality of factors associated with the payment transaction;
dynamically select, based on the plurality of factors, a payment tokenization method from one of a network tokenization method, a gateway tokenization method, or a third party tokenization method;
dynamically select, based on the plurality of factors, a token exchange method from one of a client-side exchange method, a server-side exchange method, or a direct exchange method; and
process the payment transaction according to the selected payment tokenization method and the selected token exchange method.

14. The system as recited in claim 13, further comprising instructions that, when executed by the at least one processor, cause the system to:
determine a plurality of relationships between two or more of a sender of the payment transaction, a recipient of the payment transaction, a payment gateway system, a card network system, and a payment system; and
dynamically select, based on the determined plurality of relationships, the payment tokenization method and the token exchange method.

15. The system as recited in claim 13, further comprising instructions that, when executed by the at least one processor, cause the system to identify the plurality of factors by:
identifying a first set of factors for selecting the payment tokenization method, the first set of factors comprising one or more of a payment credential of the first user, a payment credential of the second user, a payment gateway system associated with a recipient of the payment transaction, a card network system associated with a payment authorization number of the first user, or a risk level associated with the payment transaction; and
identifying a second set of factors for selecting the token exchange method, the second set of factors comprising one or more of an identity of the first user, an identity of the second user, a payment credential of the first user, a card network system associated with a payment authorization number of the first user, or a risk level associated with the payment transaction.

16. The system as recited in claim 13, further comprising instructions that, when executed by the at least one processor, cause the system to:
determine, based on the plurality of factors, that a plurality of payment tokenization methods are available for the payment transaction;
determine, from the plurality of available payment tokenization methods, a payment tokenization method with a fastest estimated processing time;
select the payment tokenization method with the fastest estimated processing time for processing the payment transaction; and
process the payment transaction using the selected payment tokenization method.

17. The system as recited in claim 13, further comprising instructions that, when executed by the at least one processor, cause the system to:
determine, based on the plurality of factors, a backup payment tokenization method from one of a network tokenization method, a gateway tokenization method, or a third party tokenization method and a backup token exchange method from one of a client-side exchange method, a server-side exchange method, or a direct exchange method;
detect that the selected payment tokenization method or the selected token exchange method fails;
select, based on the selected payment tokenization method or the selected token exchange method failing, the backup payment tokenization method or the backup token exchange method for processing the payment transaction; and
process the payment transaction using the selected backup payment tokenization method or the selected backup token exchange method.

18. A non-transitory computer readable storage medium comprising instructions that, when executed by the at least one processor, cause a computer system to:
receive, from a client device associated with a first user, a request to initiate a payment transaction;
identify a plurality of factors associated with the payment transaction;
dynamically select, based on the plurality of factors, a payment tokenization method from one of a network tokenization method, a gateway tokenization method, or a third party tokenization method;
dynamically select, based on the plurality of factors, a token exchange method from one of a client-side exchange method, a server-side exchange method, or a direct exchange method; and
process the payment transaction according to the selected payment tokenization method and the selected token exchange method.

19. The non-transitory computer readable storage medium as recited in claim 18, further comprising instructions that, when executed by the at least one processor, cause the system to identify the plurality of factors comprises identifying a set of factors for determining the payment tokenization method, the set of factors comprising at least one of a payment credential of the first user, a payment credential of the second user, a payment gateway system associated with a recipient of the payment transaction, a card network system associated with a payment authorization number of the first user, or a risk level associated with the payment transaction.

20. The non-transitory computer readable storage medium as recited in claim 18, further comprising instructions that, when executed by the at least one processor, cause the system to identify a set of factors for determining the token exchange method, the set of factors comprising at least one of an identity of the first user, an identity of the second user, a payment credential of the first user, a card network system associated with a payment authorization number of the first user, or a risk level associated with the payment transaction.
